(19) United States
(12) Patent Application Publication
(10) Pub. No.: US 2026/0132336 A1
(43) Pub. Date: May 14, 2026

(54) DUST SUPPRESSION COMPOSITION AND METHODS OF USE THEREOF

(71) Applicant: ARIZONA BOARD OF REGENTS ON BEHALF OF ARIZONA STATE UNIVERSITY, Scottsdale, AZ (US)

(72) Inventors: Ravi Yellavajjala, Tempe, AZ (US); Maedeh Hesami, Tempe, AZ (US)

(21) Appl. No.: 19/388,713

(22) Filed: Nov. 13, 2025

Related U.S. Application Data
(60) Provisional application No. 63/720,101, filed on Nov. 13, 2024.

(51) Int. Cl. C09K 17/32; C08J 3/075; C08J 9/28; C08J 9/38; E01C 21/00

(52) U.S. Cl. CPC C09K 17/32; C08J 3/075; C08J 9/283; C08J 9/38; E01C 21/00; C08J 2201/0484; C08J 2205/022; C08J 2303/12; E01C 2301/50

(57) ABSTRACT

The present invention relates to particulate suppression compositions and methods of use thereof. In embodiments, the particulate suppression compositions and methods can be used to suppress dust. The compositions comprise amylopectin starch hydrogel powders and regenerated amylopectin starch hydrogels.

This application claims priority to U.S. Provisional Application No. 63/720,101 filed on Nov. 13, 2024, the entire contents of which are incorporated herein by reference.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records but otherwise reserves any and all copyright rights.

### FIELD OF THE INVENTION

The present invention relates to dust suppression compositions and methods of use thereof.

### BACKGROUND OF THE INVENTION

Airborne dust emission has always imposed adverse effects on human health (e.g., respiratory problems, and cardiovascular issues) and the surrounding environment (e.g., contamination of water and degradation of vegetation). A commonly used short-term method to mitigate airborne dust is spraying water on the soil surface. As the water evaporates and the surface dries, a thin and brittle crust is formed, providing only temporary relief.

### SUMMARY OF THE INVENTION

Aspects of the invention are drawn towards a biocompatible dust mitigation composition. In embodiments, the composition comprises a regenerated amylopectin starch hydrogel (RASH) composition. In embodiments, the RASH composition comprises high amylopectin cornstarch. In embodiments, the high amylopectin starch comprises about 90 wt. % amylopectin, about 91 wt. % amylopectin, about 92 wt. % amylopectin, about 93 wt. % amylopectin, about 94 wt. % amylopectin, about 95 wt. % amylopectin, about 96 wt. % amylopectin, about 97 wt. % amylopectin, about 98 wt. % amylopectin, about 99 wt. % amylopectin, or greater than about 99 wt. % amylopectin. In embodiments, the composition is shelf stable. In embodiments, the composition comprises a pH of about 6 to about 7.5. In embodiments, the composition comprises about 0.5 wt. % high amylopectin starch, about 1.0% high amylopectin starch, about 2.0 wt. % high amylopectin starch, about 3.0% wt. % high amylopectin starch, about 4.0 wt. % high amylopectin starch, about 5.0% high amylopectin starch, and greater than about 5.0 wt. % high amylopectin starch. In embodiments, the composition comprises a salt selected from the group consisting of NaCl, CaCl₂), MgCl₂, BaCl₂, NH₄Cl, or any combination thereof. In embodiments, the salt comprises about 0.01 wt. % to about 10 wt. % of the composition.

Aspects of the disclosure are drawn towards a method of producing an amylopectin starch hydrogel composition. In embodiments, the method comprising: suspending an amylopectin-rich starch in water, thereby producing a starch solution; stirring the starch solution at a temperature sufficient to induce starch gelatinization; cooling the solution to room temperature; subjecting the solution to a freeze-thaw process, thereby producing a foam; and grinding the foam into a powder, thereby producing a powder amylopectin starch hydrogel composition. In embodiments, the powder amylopectin starch hydrogel composition comprises about 90 wt. % amylopectin, about 91 wt. % amylopectin, about 92 wt. % amylopectin, about 93 wt. % amylopectin, about 94 wt. % amylopectin, about 95 wt. % amylopectin, about 96 wt. % amylopectin, about 97 wt. % amylopectin, about 98 wt. % amylopectin, about 99 wt. % amylopectin, or greater than about 99 wt. % amylopectin. In embodiments, the powder comprises a particle size of about 50 μm to about 700 μm. In embodiments, the temperature sufficient to induce starch gelatinization is about 90° C. or about greater than 90° C. In embodiments, the method further comprises adding an aqueous solution to the powder amylopectin starch hydrogel composition, thereby producing a regenerated amylopectin starch hydrogel (RASH). In embodiments, the powder comprises at least 50% particles with a particle size of at least 100 μm. In embodiments, the RASH comprises about 0.5 wt. % of the powder amylopectin starch hydrogel composition, about 1.0% of powder amylopectin starch hydrogel composition, about 2.0 wt. % of the powder amylopectin starch hydrogel composition, about 3.0% wt. % of the powder amylopectin starch hydrogel composition, about 4.0 wt. % of the powder amylopectin starch hydrogel composition, about 5.0 wt. % of the powder amylopectin starch hydrogel composition, or greater than about 5.0 wt. % of the powder amylopectin starch hydrogel composition. In embodiments, the RASH comprises about 0.01 wt. % to about 10 wt. % of a salt selected from the group consisting of NaCl, CaCl₂), MgCl₂, BaCl₂, NH₄Cl. In embodiments, the freeze-thaw process comprises subjecting the solution to a temperature to induce freezing of the solution; holding the solution at said temperature for an amount of time; and thawing the solution to about room temperature until the solution has been dehydrated. In embodiments, the freeze-thaw process is performed one or more times. In embodiments, the temperature to induce freezing is about −18° C. or less. In embodiments, the amount of time for freezing comprises about 24 hours, about 36 hours, about 48 hours, or longer than about 48 hours.

Aspects of the disclosure are drawn towards a method of suppressing particulate matter comprising applying the regenerated amylopectin starch hydrogel (RASH) described herein to a loose particulate material, thereby forming agglomerated particles. In embodiments, the RASH is homogenous. In embodiments, the RASH is regenerated in a liquid at about 65° C. to about 80° C. In embodiments, the RASH comprises a viscosity of about 0.001 P·s, to about 0.3 P·s at room temperature. In embodiments, the RASH comprises about 0.5 wt. % to about 5.0 wt. % of a powder amylopectin starch hydrogel composition. In embodiments, the applying comprises spraying. In embodiments, the agglomerated particles form a soil crust. In embodiments, the RASH is applied at about 1.0 L/m² to about 4.0 L/m². In embodiments, the soil crust comprises a threshold detachment velocity (TDV) of greater than about 25 m/s. In embodiments, the particulate matter comprises PM10, PM1, PM2.5, or a combination thereof.

Other objects and advantages of this invention will become readily apparent from the ensuing description.

### BRIEF DESCRIPTION OF THE FIGURES

FIG. 1A shows non-limiting, exemplary microscopy images of granular morphology of raw amylopectin-rich corn starch powder 2000 μm, and 50 μm.

FIG. 1B shows non-limiting, exemplary microscopy images of granular morphology of regenerated amylopectin corn starch powder at 2000 μm and 50 μm.

FIG. 2A shows non-limiting, exemplary microscopy images of granular morphology of raw normal corn starch powder at 2000 μm and 50 μm.

FIG. 2B shows non-limiting, exemplary microscopy images of granular morphology of regenerated normal corn starch powder at 2000 μm and 50 μm.

FIG. 3 shows non-limiting, exemplary image of regenerated corn starch hydrogel (RCSH) solution and amylopectin corn starch hydrogel (RASH) solution

FIG. 4A shows a non-limiting, exemplary photograph of the visual appearance of a dried treated surface with regenerated normal starch hydrogel (RNSH).

FIG. 4B shows a non-limiting, exemplary photograph of the visual appearance of a dried treated surface with regenerated amylopectin starch hydrogel (RASH)

FIG. 5 shows non-limiting, exemplary particle size distribution of pulverized regenerated amylopectin starch crystal.

FIG. 6 shows a non-limiting, exemplary graph of particle size distribution of AZ soil used for in-lab tests.

FIG. 7A shows non-limiting, exemplary images of microstructural analysis of Surface Morphology for Dust Samples treated with Distilled Water.

FIG. 7B shows non-limiting, exemplary images of microstructural analysis of Surface Morphology for Dust Samples treated with 10% wt. NaCl Brine Solution.

FIG. 7C shows non-limiting, exemplary images of microstructural analysis of Surface Morphology for Dust Samples treated with 1% wt. RASH Solution.

FIG. 8 shows non-limiting, exemplary images of microstructural cross-sections pf soils treated with 1% wt. RASH at 1000 μm scale and 50 μm scale.

FIG. 9 shows non-limiting, exemplary data and diagram indicating surface elemental composition of RASH-treated dust samples analyzed via LIBS at six locations.

FIG. 10A shows non-limiting, exemplary elemental composition (% wt.) across sequential depth layers in untreated dust sample after drilling LIBS analysis.

FIG. 10B shows non-limiting, exemplary elemental composition (% wt.) across sequential depth layers in 1% wt. RASH-treated dust sample after drilling LIBS analysis.

FIG. 11 shows non-limiting, exemplary image of a PI-SWERL test device.

FIG. 12 shows non-limiting, exemplary graph of wind speed in PI-SWERL test setup.

FIG. 13 shows non-limiting, exemplary graph of concentration of particulate matter (PM10) for salt-treated and water-treated samples in varying wind velocities.

FIG. 14 shows a non-limiting, exemplary graph of concentration of particulate matter (PM-10) relative to wind velocity for various weight concentrations of RASH-treated samples.

FIG. 15A shows a non-limiting, exemplary photograph of the surface morphology of 1% wt. RASH treated surface post treatment. 1% wt. RASH. Panel B shows 3% wt. RASH treated soil.

FIG. 15B shows a non-limiting, exemplary photograph of the surface morphology of 3% wt. RASH treated surface post treatment

FIG. 16 shows non-limiting, exemplary photographs of appearance of treated surface following the PI-SWERL test.

FIG. 17 shows non-limiting, exemplary image of a flat-nose penetration test setup for evaluating surface crust strength.

FIG. 18 shows non-limiting, exemplary graph of surface penetration resistance of treated AZ soil.

FIG. 19 shows a non-limiting, exemplary photograph of the visual appearance of crust thickness of 1% wt. RASH-treated surface and 10% wt. NaCl-treated surface.

FIG. 20 shows non-limiting, exemplary photographs of the location and ground view of the test site.

FIG. 21 shows non-limiting, exemplary graph of particle size distribution of the construction site.

FIG. 22A shows a non-limiting, exemplary photograph of the visual appearance of the soil in construction site A with well-graded sand. Panel B shows construction site B with well-graded sand with gravel.

FIG. 22B shows a non-limiting, exemplary photograph of the visual appearance of the soil in construction site B with well-graded sand with gravel.

FIG. 23 shows non-limiting, exemplary configuration of test plots layout for each construction site.

FIG. 24 shows a non-limiting, exemplary photograph of a view of the field trial area after treatment.

FIG. 25A shows a non-limiting, exemplary graph of particulate Matter (PM10) Concentration as a Function of Velocity in the PI-SWERL Test between water treatment and other dust suppressant solutions at construction Site A, 48 Hours Post-Treatment. Panel B shows comparison between effective dust suppressants.

FIG. 25B shows a non-limiting, exemplary graph of particulate Matter (PM10) Concentration as a Function of Velocity in the PI-SWERL Test between effective dust suppressants at construction Site A, 48 Hours Post-Treatment.

FIG. 26A shows non-limiting, exemplary photographs of the visual Appearance of Field Treated Surfaces 48 Hours Post-Treatment with 1% RASH. Panel B shows surfaces treated with 10% wt. NaCl.

FIG. 26B shows non-limiting, exemplary photographs of the visual Appearance of Field Treated Surfaces 48 Hours Post-Treatment with 10% wt. NaCl.

FIG. 27A shows non-limiting, exemplary graphs of particulate matter (PM10) concentration as a function of velocity at construction Site A at different time intervals (2 Days, 5 Days, 10 Days, and 20 Days) post-application of 1% RASH treatment. Panel B shows 10% NaCl treatment.

FIG. 27B shows non-limiting, exemplary graphs of particulate matter (PM10) concentration as a function of velocity at construction Site A at different time intervals (2 Days, 5 Days, 10 Days, and 20 Days) post-application of 10% NaCl treatment.

FIG. 28A shows non-limiting, exemplary graphs of PM10 concentration versus velocity in PI-SWERL test at construction Site B, 48 Hours after Treatment comparing water treatment with other dust suppressants. Panel B shows comparison of effective dust suppressants.

FIG. 28B shows non-limiting, exemplary graphs of PM10 concentration versus velocity in PI-SWERL test at construction Site B, 48 Hours after Treatment comparing effective dust suppressants.

FIG. 29A shows non-limiting, exemplary photographs of the appearance of field treated surfaces 48 hours post-treatment with 1% RASH at construction site B. Panel A shows surfaces treated with 1% RASH. Panel B shows surfaces treated with 10% wt. NaCl

FIG. 29B shows non-limiting, exemplary photographs of the appearance of field treated surfaces 48 hours post-treatment with 10% wt. NaCl at construction site B.

FIG. 30A shows non-limiting, exemplary graphs of particulate matter (PM10) Concentration as a function of velocity at construction Site B at different time intervals (2 Days, 5 Days, 10 Days, and 20 Days) Post-Application with 1% RASH treatment. Panel B shows 10% NaCl treatment.

FIG. 30B shows non-limiting, exemplary graphs of particulate matter (PM10) Concentration as a function of velocity at construction Site B at different time intervals (2 Days, 5 Days, 10 Days, and 20 Days) Post-Application with 10% NaCl treatment.

FIG. 31 shows non-limiting, exemplary images of (a) Lignin-Chitosan (HA), (b) Hydroxyethyl cellulose (HB), and (c) Alkali-treated starch (HC) hydrogel solutions prior to application.

### DETAILED DESCRIPTION OF THE INVENTION

Aspects of the disclosure are drawn towards a biocompatible dust mitigation composition. Detailed descriptions of one or more embodiments are provided herein. However, that the present invention can be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification can refer to “one,” but it is also consistent with “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably. Specifically, each of the terms used herein is consistent with the common United States patent law definition of“comprising” and is therefore interpreted to be an open term meaning “at least the following,” and is also interpreted not to exclude additional features, limitations, aspects, etc. Thus, for example, “a process involving steps a, b, and c” can refer to a process that includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

Before explaining at least one embodiment of the disclosure in detail, the disclosure is not necessarily limited in its application to the details set forth in the following description or exemplified by the examples. The disclosure is capable of other embodiments or of being practiced or carried out in various ways. Other compositions, compounds, methods, features, and advantages of the present disclosure will be or become apparent to one having ordinary skill in the art upon examination of the following drawings, detailed description, and examples. All such additional compositions, compounds, methods, features, and advantages can be included within this description, and be within the scope of the present disclosure.

Aspects of the disclosure are drawn towards a biocompatible dust mitigation composition. In embodiments, the composition comprises a regenerated amylopectin starch hydrogel (RASH). In embodiments, the RASH comprises a high amylopectin starch. In some embodiments, the high amylopectin starch is high amylopectin cornstarch. As used herein, the “hydrogel” can refer to a RASH or RASH composition described herein. As used herein, the term “hydrogel” can refer to a polymer or polymer network that can absorb water, retain water, or absorb and retain water.

As used herein, the term “regenerated” can refer to a starch powder that has been added to water. For example, the water can be at about 65° C. or above 65° C. For example, the regenerated hydrogels described herein can be produced by hydrating a high amylopectin starch powder described herein. In embodiments, the high amylopectin starch comprises high amylopectin starch produced by a method described herein. For example, in some embodiments, the high amylopectin starch powder has been added to water and stirred at a temperature sufficient to induce starch gelatinization, then cooled to room temperature, and subjected to a freeze-thaw process.

As used herein, the term “room temperature” can refer to about 15° C. to about 25° C. However, this temperature can be adjusted by one of ordinary skill in the art.

As used herein, the phrase “high amylopectin” can refer to a composition that comprises less than about 80% amylopectin, about 80% amylopectin, about 90% amylopectin, about 95% amylopectin, about 90% amylopectin, about 91% amylopectin, about 92% amylopectin, about 93% amylopectin, about 94% amylopectin, about 95% amylopectin, about 96% amylopectin, about 97% amylopectin, about 98% amylopectin, about 99% amylopectin, or greater than about 99% amylopectin, or about 100% amylopectin.

In embodiments, the dust mitigation composition described herein is shelf stable. As used herein, the term “self stable” can refer to the ability of the composition to be stored at room temperature without significant degradation. For example, the regenerated powder described herein can be stored in sealed containers at room temperature without significant degradation. In embodiments, the composition can be shelf stable for about 6 months, about 1 year, about 18 months, about 24 months, or greater than about 24 months. In some embodiments, the composition is shelf stable for at least 2 years. In some embodiments, the composition is shelf stable at room temperature and relative humidity of about 50% or less.

For each use, the powder only needs to be mixed with hot water (above 65° C.) to prepare the dust suppressant solution. In embodiments, the composition described herein can be at a pH appropriate for the application it is being used. For example, the composition can comprise a pH of less than about 6, about 6, about 6.5, about 7, about 7.5, about 8, about 8.5, or greater than about 8.5. This can be determined and adjusted by one of ordinary skill in the art.

In embodiments, the RASH (RASH) can be regenerated upon the addition of hot water, thereby forming an amylopectin corn starch hydrogel. In some embodiments, the temperature can comprise about 65° C. to about 80° C. In embodiments, the temperature can comprise less than about 50° C., about 50° C., about 55° C., about 65° C., about 70° C., about 75° C., about 80° C., about 85° C., about 90° C., about 95° C., about 100° C., or greater than about 100° C.

In embodiments, the RASH can comprise less than about 2 wt. % to greater than about 15 wt. % high amylopectin starch. For example, the RASH can comprise about 2 wt. % to about 10 wt. % high amylopectin starch. In embodiments, the hydrogel can comprise less than about 0.1 wt. % high amylopectin starch, about 0.25 wt. % high amylopectin starch, about 0.5 wt. % high amylopectin starch, about 0.75 wt. % high amylopectin starch, about 1.0 wt. % high amylopectin starch, about 1.25 wt. % high amylopectin starch, about 1.5 wt. % high amylopectin starch, about 1.75 wt. % high amylopectin starch, about 2.0 wt. % high amylopectin starch, about 2.25 wt. % high amylopectin starch, about 2.5 wt. % high amylopectin starch, about 2.75 wt. % high amylopectin starch, about 3.0 wt. % high amylopectin starch, about 3.25 wt. % high amylopectin starch, about 3.5 wt. %, high amylopectin starch, about 3.75 wt. % high amylopectin starch, about 4.0 wt. % high amylopectin starch, about 4.25 wt. % high amylopectin starch, about 4.5 wt. % high amylopectin starch, about 4.75 wt. % high amylopectin starch, about 5.0 wt. % high amylopectin starch, about 5.5 wt. % high amylopectin starch, about 6.0 wt. % high amylopectin starch, about 6.5 wt. % high amylopectin starch, about 7.0 wt. % high amylopectin starch, about 7.5 wt. % high amylopectin starch, about 8.0 wt. % high amylopectin starch, about 8.5 wt. % high amylopectin starch, about 9.0 wt. % high amylopectin starch, about 9.5 wt. % high amylopectin starch, about 10.0 wt. % high amylopectin starch, and greater than about 10.0 wt. % high amylopectin starch. The wt. % of high amylopectin starch can be determined by one of ordinary skill in the art depending on the application.

In embodiments, the hydrogel can further comprise a salt. For example, the hydrogel comprises a chloride salt. In embodiments, the chloride salt can be any chloride salt known in the art or any combination thereof. For example, the chloride salt can be selected from the group consisting of NaCl, CaCl₂), MgCl₂, BaCl₂, NH₄Cl, or any combination thereof.

In embodiments, the hydrogel can comprise about 0 wt. % to about 15 wt. % salt. For example, the hydrogel can comprise a chloride salt at about less than about 0.01 wt. % to about 10 wt. % of the hydrogel. For example, the chloride salt can comprise 0 wt. %, less than about 0.01 wt. %, about 0.01 wt. %, about 0.025 wt. %, about 0.05 wt. %, about 0.075 wt. %, about 0.1 wt. %, about 0.25 wt. %, about 0.5 wt. %, about 0.75 wt. %, about 1.0 wt. %, about 1.25 wt. %, about 1.5 wt. %, about 1.75 wt. %, about 2.0 wt. %, about 2.25 wt. %, about 2.5 wt. %, about 2.5 wt. %, about 2.75 wt. %, about 3.0 wt. %, about 3.25 wt. %, about 3.5 wt. %, about 3.75 wt. %, about 4.0 wt. %, about 4.25 wt. %, about 4.5 wt. %, about 4.75 wt. %, about 5.0 wt. %, about 5.25 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, about 10 wt. %, or greater than about 10.0 wt. % chloride salt.

In embodiments, there are synergistic effects between the hydrogel and a certain amount of salt in certain situations described herein. For example, the concentration of NaCl in an example described herein was about 3%, and it demonstrated a synergistic effect with the hydrogel on location (Site B) during the initial 48 hours. However, over a longer period (for example, after about 10 days), the composite hydrogel (about 1% RASH-about 3% NaCl) exhibited weaker performance compared to RASH alone. This reduced long-term effectiveness can be attributed to the effect of NaCl on starch gelatinization, which can lead to structural breakdown of the hydrogel over time. Therefore, whether to include a salt, the type of salt, and the amount of the salt can be determined based upon the application to be used by a person of ordinary skill in the art.

Aspects of the disclosure are drawn towards a method of producing an amylopectin starch hydrogel composition. In embodiments, the method comprises suspending amylopectin-rich starch in water, thereby producing a starch solution; stirring the starch solution at a temperature sufficient to induce starch gelatinization; cooling the solution; subjecting the solution to a freeze-thaw process, thereby producing a foam; and grinding the foam into a powder, thereby producing a powder amylopectin starch hydrogel (RASH) composition.

In embodiments, the freeze-thaw process comprises subjecting the solution to a temperature sufficient to induce freezing of the solution and thawing the solution to about room temperature until the solution has been dehydrated. In embodiments, the freeze-thaw process is performed one or more times. For example, the freeze-thaw process can be performed as many times as necessary to dehydrate the solution. In embodiments, the freeze-thaw process is performed one or more times. In some embodiments, the freeze-thaw process is performed twice. In embodiments, the temperature to induce freezing can be about −18° C. or less. In embodiments, the amount of time for freezing comprises about 24 hours, about 36 hours, about 48 hours, or longer than about 48 hours.

In some embodiments, the starch solution can comprise about 2 wt. % to about 10 wt. % of the amylopectin-rich starch. In some embodiments, the starch solution can comprise about 5 wt. % of the amylopectin-rich starch. When the wt. % changes, one of ordinary skill in the art can adjust other parameters (e.g., length and time of heating, temperature, etc.).

In embodiments, the powder amylopectin rich starch hydrogel composition can comprise about amylopectin about 80 wt. % amylopectin, about 85 wt. % amylopectin, about 90 wt. % amylopectin, about 91 wt. % amylopectin, about 92 wt. % amylopectin, about 93 wt. % amylopectin, about 94 wt. % amylopectin, about 95 wt. % amylopectin, about 96 wt. % amylopectin, about 97 wt. % amylopectin, about 98 wt. % amylopectin, about 99 wt. % amylopectin, greater than about 99 wt. % amylopectin, waxy corn starch, or any combination thereof.

In embodiments, the powder amylopectin starch hydrogel (RASH) composition comprises a particle size of about 50 μm to about 700 μm. In embodiments, the powder comprises at least 50% of particles with a particle size of at least 100 μm.

In embodiments, the temperature sufficient to induce starch gelatinization is about 50° C. to greater than 90° C. In embodiments, the temperature to induce starch gelatinization comprises about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., or greater than about 125° C.

In embodiments, the powder amylopectin starch hydrogel composition can form a hydrogel solution upon addition of an aqueous solution. For example, adding an aqueous solution to the powder amylopectin starch hydrogel composition can produce the hydrogel or as described herein.

In embodiments, the hydrogel can comprise less than about 0.1 wt. % powder amylopectin starch hydrogel composition, about 0.25 wt. % powder amylopectin starch hydrogel composition, about 0.5 wt. % powder amylopectin starch hydrogel composition, about 0.75 wt. % powder amylopectin starch hydrogel composition, about 1.0 wt. % powder amylopectin starch hydrogel composition, about 1.25 wt. % powder amylopectin starch hydrogel composition, about 1.5 wt. % powder amylopectin starch hydrogel composition, about 1.75 wt. % powder amylopectin starch hydrogel composition, about 2.0 wt. % powder amylopectin starch hydrogel composition, about 2.25 wt. % powder amylopectin starch hydrogel composition, about 2.5 wt. % powder amylopectin starch hydrogel composition, about 2.75 wt. % powder amylopectin starch hydrogel composition, about 3.0 wt. % powder amylopectin starch hydrogel composition, about 3.25 wt. % powder amylopectin starch hydrogel composition, about 3.5 wt. % powder amylopectin starch hydrogel composition, about 3.75 wt. % powder amylopectin starch hydrogel composition, about 4.0 wt. % powder amylopectin starch hydrogel composition, about 4.25 wt. % powder amylopectin starch hydrogel composition, about 4.5 wt. % powder amylopectin starch hydrogel composition, about 4.75 wt. % powder amylopectin starch hydrogel composition, about 5.0 wt. % powder amylopectin starch hydrogel composition, about 5.5 wt. % powder amylopectin starch hydrogel composition, about 6.0 wt. % high amylopectin starch, about 6.5 wt. % high amylopectin starch, about 7.0 wt. % powder amylopectin starch hydrogel composition, about 7.5 wt. % powder amylopectin starch hydrogel composition, about 8.0 wt. % powder amylopectin starch hydrogel composition, about 8.5 wt. % powder amylopectin starch hydrogel composition, about 9.0 wt. % powder amylopectin starch hydrogel composition, about 9.5 wt. % powder amylopectin starch hydrogel composition, about 10.0 wt. % powder amylopectin starch hydrogel composition, or greater than about 10.0 wt. % powder amylopectin starch hydrogel composition. The wt. % of powder amylopectin starch hydrogel composition can be determined by one of ordinary skill in the art depending on the application.

In embodiments, the hydrogel can further comprise a salt. For example, the hydrogel comprises a chloride salt. In embodiments, the chloride salt can be any chloride salt known in the art or any combination thereof. For example, the chloride salt can be selected from the group consisting of NaCl, CaCl₂), MgCl₂, BaCl₂, NHCl, or any combination thereof.

In embodiments, the hydrogel can comprise about 0 wt. % to about 15 wt. % salt. For example, the hydrogel can comprise a chloride salt at about less than about 0.01 wt. % to about 10 wt. % of the hydrogel. For example, the chloride salt can comprise 0 wt. %, less than about 0.01 wt. %, about 0.01 wt. %, about 0.025 wt. %, about 0.05 wt. %, about 0.075 wt. %, about 0.1 wt. %, about 0.25 wt. %, about 0.5 wt. %, about 0.75 wt. %, about 1.0 wt. %, about 1.25 wt. %, about 1.5 wt. %, about 1.75 wt. %, about 2.0 wt. %, about 2.25 wt. %, about 2.5 wt. %, about 2.5 wt. %, about 2.75 wt. %, about 3.0 wt. %, about 3.25 wt. %, about 3.5 wt. %, about 3.75 wt. %, about 4.0 wt. %, about 4.25 wt. %, about 4.5 wt. %, about 4.75 wt. %, about 5.0 wt. %, about 5.25 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, about 10 wt. %, or greater than about 10.0 wt. % chloride salt.

Aspects of the disclosure are drawn towards a method of suppressing particulate matter comprising applying an amylopectin starch hydrogel composition as described herein to a loose particulate material, thereby forming agglomerated particles. In embodiments, the agglomerated particles form a soil crust.

In embodiments, the method comprises applying regenerated amylopectin starch hydrogel (RASH) as described herein to a loose particulate material, thereby forming agglomerated particles. In embodiments, the RASH can comprise less than about 0.5 wt. % to greater than about 15.0 wt. % of the RASH described herein. For example, the RASH can comprise about 0.1 wt. % powder amylopectin starch hydrogel composition, about 0.25 wt. % powder amylopectin starch hydrogel composition, about 0.5 wt. % powder amylopectin starch hydrogel composition, about 0.75 wt. % powder amylopectin starch hydrogel composition, about 1.0 wt. % powder amylopectin starch hydrogel composition, about 1.25 wt. % powder amylopectin starch hydrogel composition, about 1.5 wt. % powder amylopectin starch hydrogel composition, about 1.75 wt. % powder amylopectin starch hydrogel composition, about 2.0 wt. % powder amylopectin starch hydrogel composition, about 2.25 wt. % powder amylopectin starch hydrogel composition, about 2.5 wt. % powder amylopectin starch hydrogel composition, about 2.75 wt. % powder amylopectin starch hydrogel composition, about 3.0 wt. % powder amylopectin starch hydrogel composition, about 3.25 wt. % powder amylopectin starch hydrogel composition, about 3.5 wt. % powder amylopectin starch hydrogel composition, about 3.75 wt. % powder amylopectin starch hydrogel composition, about 4.0 wt. % powder amylopectin starch hydrogel composition, about 4.25 wt. % powder amylopectin starch hydrogel composition, about 4.5 wt. % powder amylopectin starch hydrogel composition, about 4.75 wt. % powder amylopectin starch hydrogel composition, about 5.0 wt. % powder amylopectin starch hydrogel composition, about 5.5 wt. % powder amylopectin starch hydrogel composition, about 6.0 wt. % high amylopectin starch, about 6.5 wt. % high amylopectin starch, about 7.0 wt. % powder amylopectin starch hydrogel composition, about 7.5 wt. % powder amylopectin starch hydrogel composition, about 8.0 wt. % powder amylopectin starch hydrogel composition, about 8.5 wt. % powder amylopectin starch hydrogel composition, about 9.0 wt. % powder amylopectin starch hydrogel composition, about 9.5 wt. % powder amylopectin starch hydrogel composition, about 10.0 wt. % powder amylopectin starch hydrogel composition, or greater than about 10.0 wt. % powder amylopectin starch hydrogel composition.

In some embodiments, the RASH is homogenous.

In embodiments, the RASH can comprise a viscosity of about 0.001 P·s, to about 0.3 P·s. For example, the RASH can comprise a viscosity of about 0.001 P·s, about 0.0015 P·s, about 0.0015 P·s, about 0.00175 P·s, about 0.002 P·s, about 0.0025 P·s, about 0.003 P·s, about 0.004 P·s, about 0.0045 P·s, about 0.005 P·s, about 0.006 P·s, about 0.0077 P·s, about 0.009 P·s, about 0.01 P·s, about 0.0125 P·s, about 0.015 P·s, about 0.0185 P·s, about 0.0225 P·s, about 0.0275 P·s, about 0.03 P·s, about 0.04 P·s, about 0.05 P·s, about 0.06 P·s, about 0.07 P·s, about 0.08 P·s, about 0.09 P·s, about 0.1 P·s, about 0.125 P·s, about 0.15 P·s, about 0.175 P·s, about 0.2 P·s, about 0.25 P·s, about 0.3 P·s, about 0.35 P·s, about 0.40 P·s, or about 0.5 P·s.

In embodiments, the RASH is applied by spraying. However, any other method of application known in the art can be used.

In embodiments, the hydrogel can be applied at a dosage that can be determined by one of ordinary skill in the art, depending upon the concentration of the solution as well as the surface to which it will be applied. In some embodiments, the higher application rates can produce increased drying shrinkage, while lower rates can be insufficient to completely wet the surface. Therefore, appropriate dosage can be determined by one of ordinary skill in the art. The dosage range can depend on the hydrogel's water-holding capacity, the surface type, and environmental conditions. Therefore, the chosen dosage will strike a balance between sufficient surface coverage and minimal shrinkage, to produce optimal dust suppression without over-application. In embodiments, the dosage can comprise about 1.0 L/m² to about 4.0 L/m². For example, the hydrogel can be applied at about 2.5 L/m². For example, the dosage can comprise less than about 1.0 L/m², about 1.5 L/m², about 2.0 L/m², about 2.5 L/m², about 3.0 L/m², about 3.5 L/m², about 4.0 L/m², about 4.5 L/m², about 5.0 L/m², about 5.5 L/m², about 6.0 L/m², or greater than about 6.0 L/m².

In embodiments, the soil crust can comprise a threshold detachment velocity (TDV) of greater than about 25 m/s. In embodiments, the soil crust can comprise a TDV of about 25 m/s or less than about 25 m/s.

In embodiments, the particulate matter can comprise PM10 to PM2.5 or a combination thereof. As used herein, the abbreviation “PM” can refer to particulate matter and the number can refer to the diameter in micrometers. For example, particulate matter less than 10 micrometers in diameter can be referred to as PM10.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

### Starch-Based Hydrogel Crystals for Enhanced Dust Suppression

Air pollution from fugitive dust poses a significant health risk to population in arid regions. Conventional chloride-based suppressants offer temporary dust control, leading to soil contamination and infrastructure corrosion. Described herein is the synthesis of a starch-based powder that regenerates into hydrogel for dust mitigation, owing to its agglomeration and crust-forming abilities. The hydrogel was synthesized by thermally degrading amylopectin-rich starch, undergoing a freeze-thaw cycle, and pulverizing into powder. The powder was then added to hot water (>65° C.) at concentrations of 0.5%, 1%, 2%, and 3% by weight of solution to form regenerated amylopectin starch hydrogel (RASH). Dust suppression performance was evaluated using PI-SWERL (Portable in-situ Wind Erosion Lab) to assess wind erosion rates, and penetration tests to measure crust strength. Results demonstrated that 1% wt. RASH achieved a 100% reduction in wind erosion rates, even at speed of 90 km/h. This is attributed to the agglomeration of soil grains and formation of thick crust. Field tests over 20 days confirmed sustained PM10 suppression in extreme arid conditions (39° C.) across various soil types. As a result, a new energy-efficient starch-based dust suppressant is described, offering a low-cost and scalable solution for long-term dust control in arid climates.

### 1. Introduction

Air pollution is one of the major environmental threats to human health, fueled by the rapid growth of industrial and technological activities. According to the World Health Organization (WHO), more than 8 million premature deaths each year are linked to air pollution (Manisalidis et al., 2020). As an important subset of air pollution, dust pollution is driven by emission of fugitive dust particles from different sectors like construction (Noh et al., 2018), agriculture (Y. Liu et al., 2022), mining (Kahraman and Erkayaoglu, 2021), and unpaved roads (Ansarinejad et al., 2023). This type of pollution entrains fine particulate matter, such as particulate matter less than 10 micrometers in diameter (PM10) and less than 2.5 micrometers in diameter (PM2.5), which are harmful to air quality and are linked to serious health issues (US EPA, 2016).

In the United States, fugitive dust from unpaved roads and construction sites alone contributes to over 34% of particulate emissions, making it a primary source of airborne particulate matter (Parvej et al., 2021). The effects of fugitive dust are far-reaching, especially in arid and semi-arid regions, where dry conditions exacerbate dust generation leading to reduced visibility, respiratory problems, waterway pollution, soil degradation, and decreased agricultural productivity (Organiscak and Randolph Reed, 2004). Various dust control techniques have been developed to stabilize top layer of soil and these techniques have one or both of the mechanisms, namely, hygroscopicity, which refers to ability to absorb and retain moisture, and agglomeration, which involves binding of soil particles (Parvej et al., 2021).

Among these techniques, chemical stabilizers are the most widely adopted in practice due to their ease of application and economic viability (Hu et al., 2020). Specifically, chloride-based salts, such as calcium chloride (CaCl₂)) and magnesium chloride (MgCl₂), are among the most widely used dust suppressants due to their hygroscopic properties (Parvej et al., 2021). However, various drawbacks have been reported, including corrosion of infrastructure (Dey and Kiran, 2022) and vehicles (Merke et al., 2025), adverse effects on soil health and fertility (Tong et al., 2023), contamination of freshwater resources (Tonu, 2023), and potential loss of biodiversity (Kolawole and Iyiola, 2023). As an alternative, bio-based polymeric dust suppressants have gained attention due to their environmental friendliness and sustainability (R. Wang et al., 2024, Xu et al., 2023), X. Wang et al., 2024, Liu et al., 2024, Yang et al., 2021, Xu et al., 2023).

Starch has emerged as an option due to its abundance, cost-effectiveness, and versatility. Starch is a natural polysaccharide primarily derived from corn, potatoes, and other plant sources, making it available and renewable. Its hydrophilic properties allow it to absorb and retain water effectively (Jalal and Kiran, 2024), while high viscosity can bind soil particles together and form a stable non-toxic soil-binding matrix (M. Liu et al., 2022). Zhu et al. (Zhu et al., 2021) proposed a starch/organo-bentonite composite liquid dust suppressant (CLDS) by using potato starch, acrylic acid, and sodium bentonite as raw materials through in situ intercalative polymerization. Jian Sun et al. (Sun et al., 2020) proposed a composite dust suppressant using starch as the base material, with methyl methacrylate and acrylamide as monomers, combined with a surfactant through graft copolymerization. Liang et al. (Liang et al., 2021) developed a starch-based superabsorbent polymer (SAP) using cassava starch as the base material. However, these materials have limitations. The composition and methods described herein address limitations of compositions known in the art. For example, the compositions described herein can provide a cost-effective, scalable approach for sustained dust suppression in diverse field conditions.

Effective dust suppression in arid and semi-arid regions remains a significant challenge, particularly where chloride-based suppressants fail to perform. This study addresses this challenge by synthesizing a shelf-stable regenerated amylopectin starch hydrogel (RASH) and evaluating its dust mitigation performance. The innovation of this study lies in employing an energy-efficient approach to modify amylopectin, the branched component of corn starch, into a powder form that can regenerate into a hydrogel upon mixing with hot water. This regeneration eliminates the need for chemical crosslinkers or synthetic additives, enabling the use of locally abundant, renewable starch resources. The performance of RASH is evaluated through a comprehensive series of laboratory tests to examine wind erosion resistance and crust strength of the treated samples. Field trials are conducted at two distinct sites to assess large-scale applicability and long-term performance under extreme environmental conditions.

### 2. Materials and Methods

### 2.1 Materials for the Synthesis of Hydrogels

Amylopectin-rich corn starch powder (90% amylopectin) and normal corn starch powder (70% amylopectin) were procured. Corn starch consists primarily of two glucose polymers: amylose and amylopectin. Amylopectin is a highly branched polysaccharide with α-1,4 linked glucose units and α-1,6 linkages at branch points. The water absorption capacity and mechanical properties of corn-based hydrogels are influenced by the relative amounts of amorphous and crystalline amylopectin. A higher proportion of amylopectin was found to enhance water absorption (Cheng et al., 2024). For this reason, amylopectin-rich corn starch, containing approximately 90% amylopectin, was used, while normal corn starch, which consists of around 70% amylopectin, was employed for comparative analysis.

### 2.2 Synthesis Process of Amylopectin Corn Starch Hydrogel Powder.

5% by wt. corn starch solution was prepared by suspending “X” grams of corn starch (amylopectin-rich and normal) in 19× mL of distilled water. The mixture was magnetically stirred for 15 minutes at 90° C. During heating, starch gelatinization was initiated as amorphous regions hydrate, causing starch granules to swell and amylose molecules to leach out. This intense expansion-imposed stress on crystalline domains, ultimately leading to the disruption of crystallites and the release of amylopectin (Schirmer et al., 2015). At this stage, the starch exhibited gel-like properties, as water became entrapped within swollen granules, forming a semi-solid matrix.

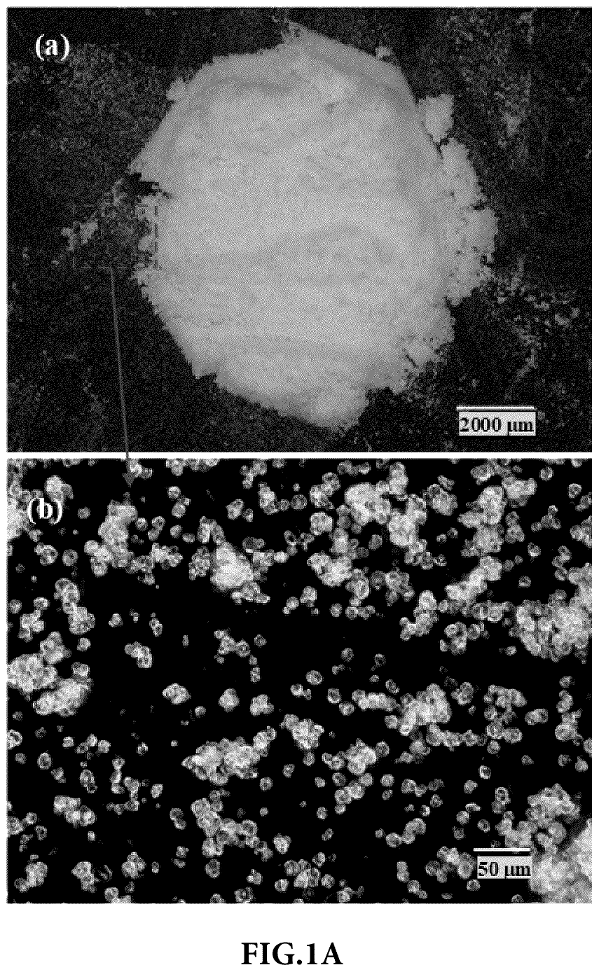

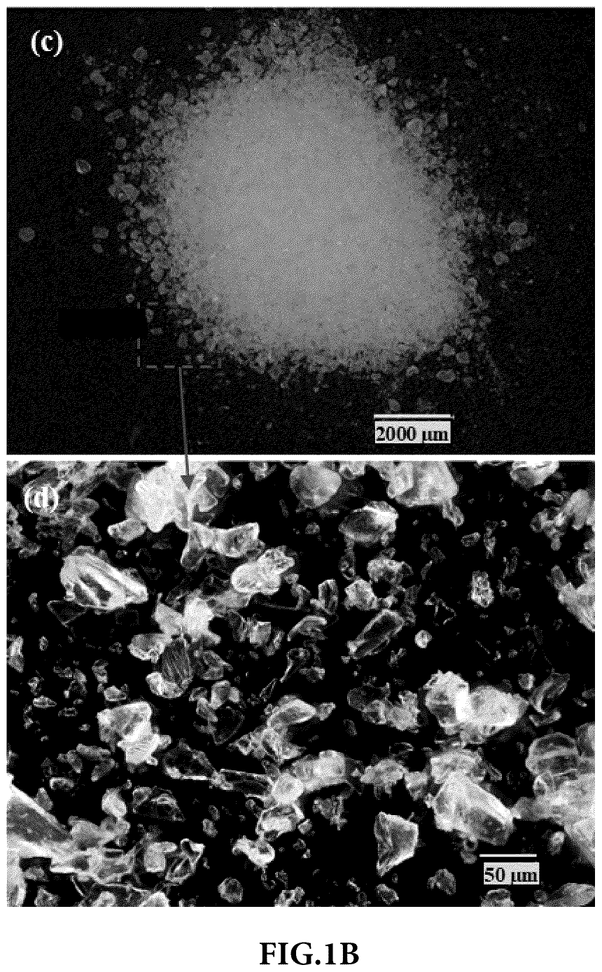

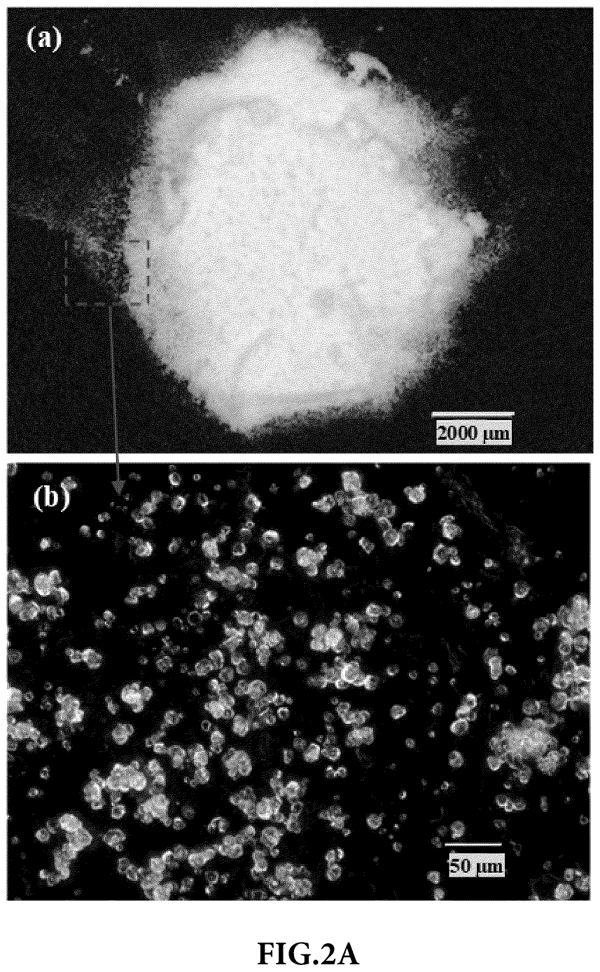

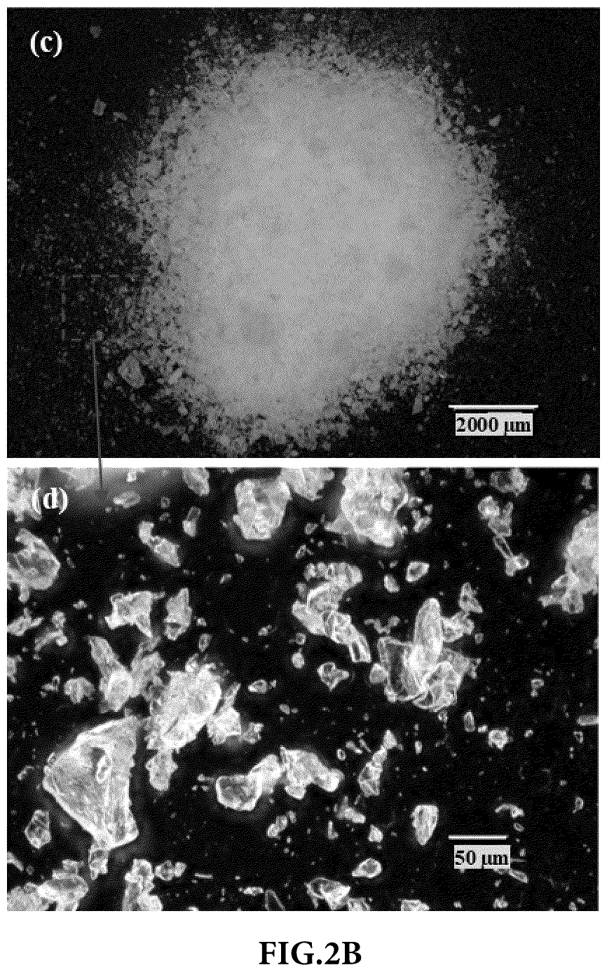

Following the gelatinization phase, retrogradation occurred as the starch solution was cooled to room temperature, initiating the re-crystallization of amylose and amylopectin chains. This retrogradation process began stabilizing the gel structure by forming hydrogen bonds, making the starch matrix firmer and less susceptible to breakdown (Zhang et al., 2024). The solution then underwent a freeze-thaw cycle, where it was frozen at −18° C. for 24 hours and subsequently thawed to room temperature. This cycle promoted further phase separation and polymer chain reorganization, expelled excess water from the gel matrix, and enhanced structural stability (Tagrida et al., 2025). After a 48-hour thawing period, the foam-like structure was ground into a fine powder. FIG. 1A-1B illustrates the granular morphology of amylopectin corn starch powder before and after treatment using a Keyence VHX-7000 optical microscope. The raw amylopectin powder, originally consisting of smaller spherical granules, transformed into angular grains post-treatment. This morphological change increased the surface area, leading to enhanced water penetration (Schirmer et al., 2015), improved solubility (Zhang et al., 2024), and accelerated hydrogel regeneration (Obadi et al., 2023). Similarly, FIG. 2A-2B presents the granular morphology of untreated and treated normal corn starch powder. Like amylopectin, the spherical morphology of the untreated starch transitioned to an angular structure post-treatment. The regenerated powders exhibited clear disruptions in granule integrity due to the physical treatment processes.

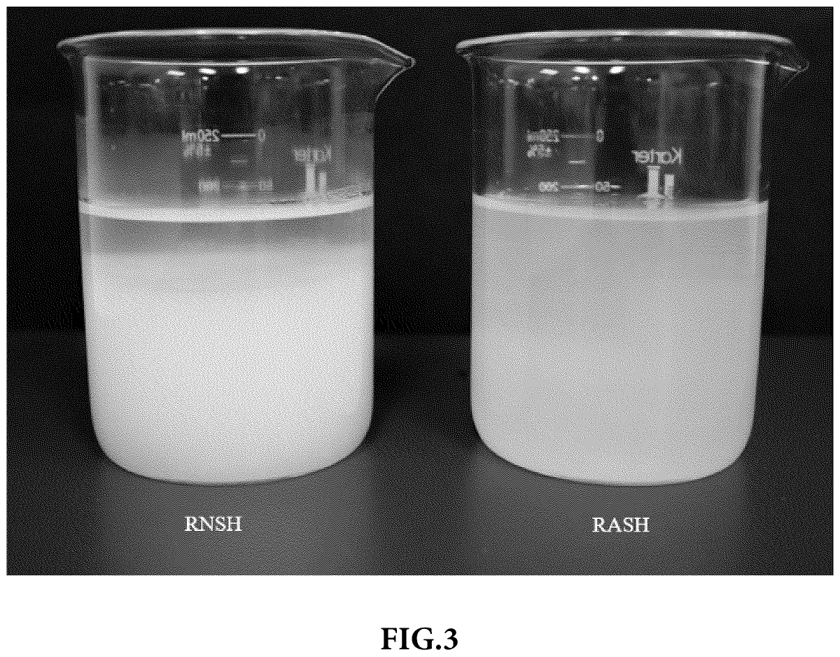

The resultant powder was introduced into warm water (>65° C.) to regenerate hydrogels for dust suppression. Different concentrations of regenerated amylopectin starch hydrogel (RASH), ranging from 0.5% to 3% by weight, were used to assess dust suppression efficiency, as shown in Table 1. FIG. 3 shows the regenerated amylopectin starch hydrogel (RASH) and regenerated normal starch hydrogel (RNSH), both at a 1% by weight. Upon regeneration, the RASH formed a homogeneous hydrogel, while the RNSH exhibited insoluble particles. The high amylopectin content in RASH enabled full dissolution in water, resulting in a stable and uniform mixture. In contrast, RNSH exhibited partial solubility due to its higher amylose content (Biduski et al., 2018), resulting in phase separation and a less consistent solution.

TABLE 1
Composition of regenerated amylopectin starch hydrogel
(RASH) at various concentrations for dust suppression.

| | 0.5% wt. | 1% wt. | 2% wt. | 3% wt. |
|---|---|---|---|---|
| Solutions | RASH | RASH | RASH | RASH |
| Regenerated | 0.5X | 1X | 2X | 3X |
| powder (g) | | | | |
| Distilled | 99.5X | 99X | 98X | 97X |
| water (g) | | | | |

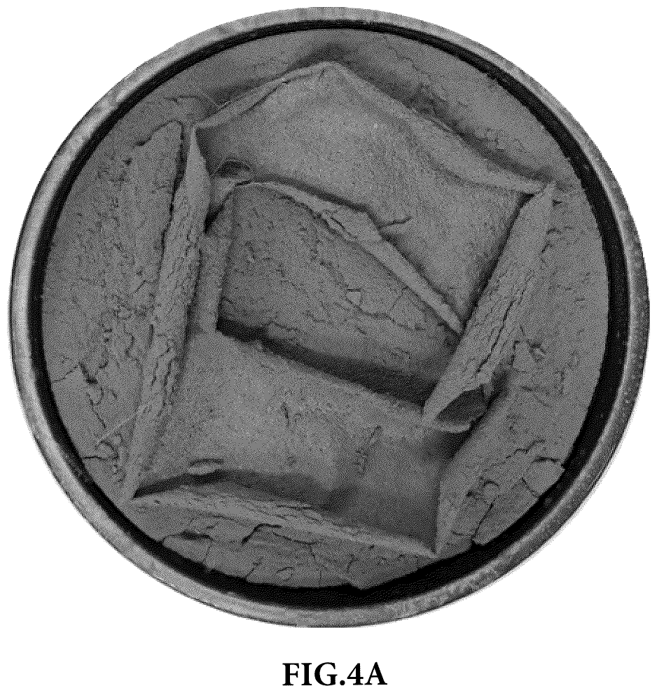

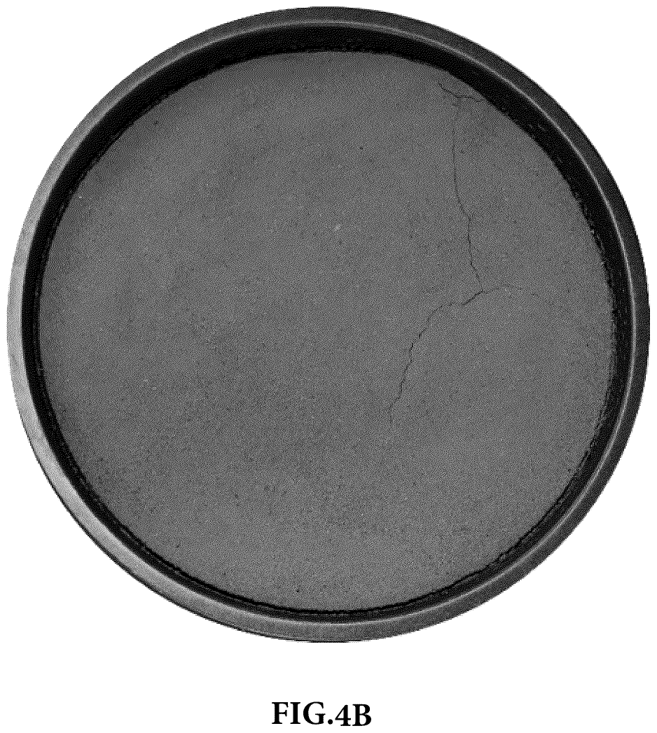

FIG. 4A-4B illustrates the preliminary application of these hydrogels on the soil surface. The RNSH developed a laminar, layered structure that detached from the soil, rendering it ineffective for dust suppression (see FIG. 4A). In contrast, the RASH formed a stable crust that fully integrated with the soil, making it a more reliable candidate for dust suppression. Consequently, RNSH was determined to be unsuitable and excluded from further investigation.

### 3. Characterization Methods for Regenerated Hydrogels.

### 3.1 Viscosity and pH Measurements.

Viscosity is an important attribute of RASH, as it helps in forming a protective crust that resist wind erosion. However, excessively high viscosity can hinder the ease of application when spraying the dust suppressant (Hu et al., 2020). It is crucial to select a dust suppressant with a viscosity that balances effectiveness with practicality. The viscosity values of RASH at varying concentrations (0.5%, 1%, 2%, and 3% wt. RASH) were measured using DHR-2, TA Instruments rheometer. Each viscosity measurement was conducted at a constant temperature of 25° C. and repeated three times to ensure accuracy and obtain reliable average values. In addition to viscosity, the pH of the hydrogel was measured using the Oakton pH meter. Maintaining the pH of the dust suppressant within a range that is compatible with the soil is essential, as it can influence both the effectiveness of the suppressant and the health of the soil ecosystem (Xu et al., 2018). The optimal pH range for soil is typically between 6.0 and 7.5, where nutrient availability is maximized, and microbial activity is preserved (Zhang YunYi et al., 2019).

The results of the viscosity and pH tests are summarized in Table 2. The pH values for all concentrations of hydrogel maintained a suitable range for soil health (Patel et al., 2023). The analysis indicated a direct correlation between the hydrogel concentration and its viscosity. As the concentration increased, the viscosity of the hydrogel also rose significantly. While higher viscosities can enhance the effectiveness of dust suppression by improving wind erosion resistance, excessively high viscosity can pose practical challenges (Hu et al., 2020). The application of the 3% wt. RASH was noted to require more energy during spraying, making it less convenient for field applications. Selecting regenerated hydrogel concentrations requires a balance between achieving effective viscosity for dust suppression and maintaining ease of application.

TABLE 2
Viscosity and pH measurements of
RASH at varying concentrations.

| Wt. of RASH | 0.5% wt. | 1% wt. | 2% wt. | 3% wt. |
|---|---|---|---|---|
| Viscosity (Pa · s) | 1.30E−03 | 2.15E−03 | 5.81E−02 | 2.95E−01 |
| pH | 6.77 | 6.78 | 6.88 | 6.92 |

### Particle Size Distribution

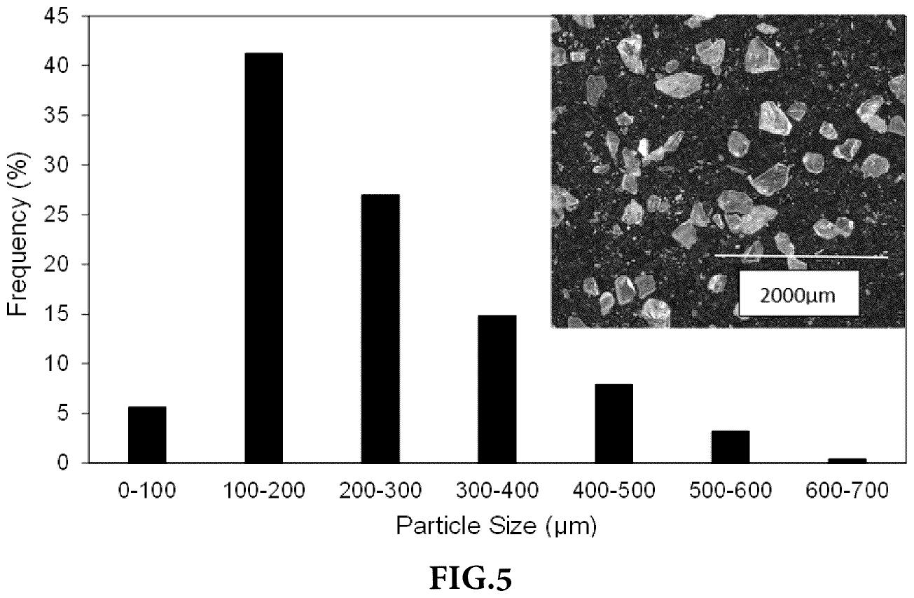

The particle size of the regenerated hydrogel powder was measured using a Keyence VHX-7000 optical microscope, analyzing 534 particles. As shown in FIG. 5, more than 40% of the particles fall within the 100-200 μm range, indicating a relatively fine and consistent powder. This size distribution is beneficial, offering enhanced solubility and minimizing the risk of agglomeration, a common issue with smaller particles of raw amylopectin-rich powder (<50 μm) (Woolley, 2023).

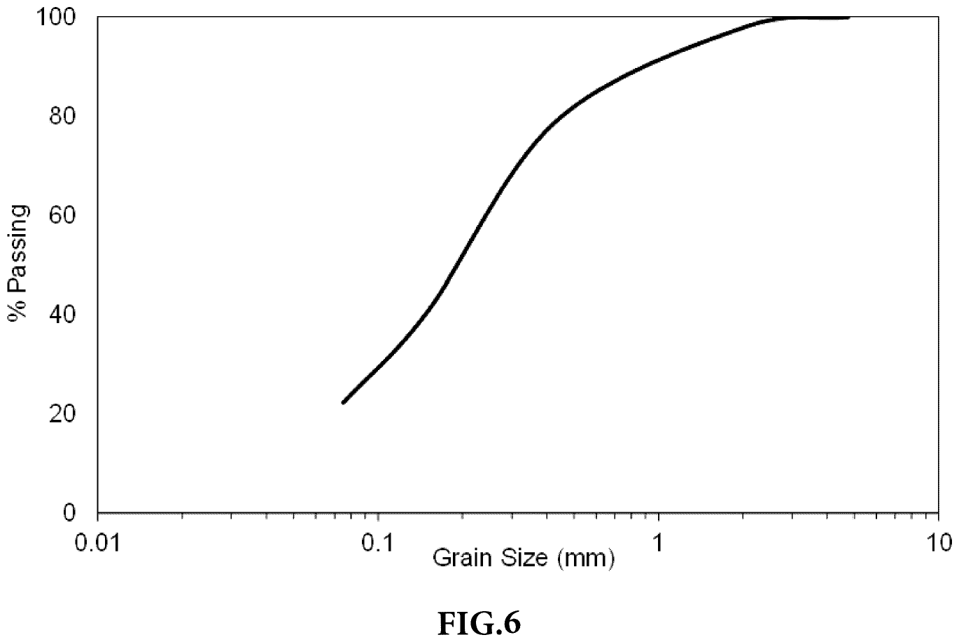

Soil samples were collected from a local site, Vertuccio Farms in Mesa, Arizona, referred to as AZ soil. The collected soil was dried in an electric oven at 50° C. to eliminate residual moisture. Then, the soil was sieved using a U.S. Standard 200 mesh (with an opening size of less than 75 μm) to remove any coarser particles, plant debris, or other larger contaminants. The grain size distribution of the soil is depicted in FIG. 6. As per the Unified Soil Classification System (USCS) (Soil and Rock, 2017), AZ soil falls under the classification of silty sand. The detailed results of the sieve analysis are summarized in Table 3.

The AZ soil was selected for testing due to its particle size distribution, which aligns with the size range most susceptible to wind erosion that is fine sand to coarse silt. Larger particles have greater resistance to wind erosion due to their higher mass, whereas smaller particles are more easily displaced. However, the introduction of moisture enhances the erosion resistance of finer particles by binding them together, while silt and clay-sized particles exhibit inter-particle cohesion due to van der Waals forces. These forces cause cations in the pore water to bond with ionic charges on the particle surfaces, increasing cohesion (Woolley, 2023). The Arizona silty sand, with a median particle size (D50) of 0.22 mm (Table 3), falls within the size range most susceptible to dust emission (Woolley, 2023).

TABLE 3
Results of sieve analysis for AZ soil

| Gravel | Sand | Fines | | Coefficient of | Coefficient of |
|---|---|---|---|---|---|
| (%) | (%) | (%) | D50(mm) | Uniformity (Cᵤ) | Curvature (C_{c}) |
| 0.00 | 77.71 | 22.29 | 0.22 | 7.44 | 0.99 |

### 3.3 Morphological Analysis of Treated Soil Surface at Microscale.

The surface morphology of the treated dust samples was assessed using Keyence Optical Microscopy (VHX-7000). Samples treated with 1% wt. RASH, 10% wt. NaCl, and distilled water were prepared by evenly spraying each solution onto 50.00 g of AZ soil. After air drying under ambient conditions, the microstructural features were evaluated at varying magnifications using Depth-from-Defocus (DFD) technology. This approach allowed for high-precision imaging, capturing detailed surface features and height variations across the samples (Da̧bski et al., 2023).

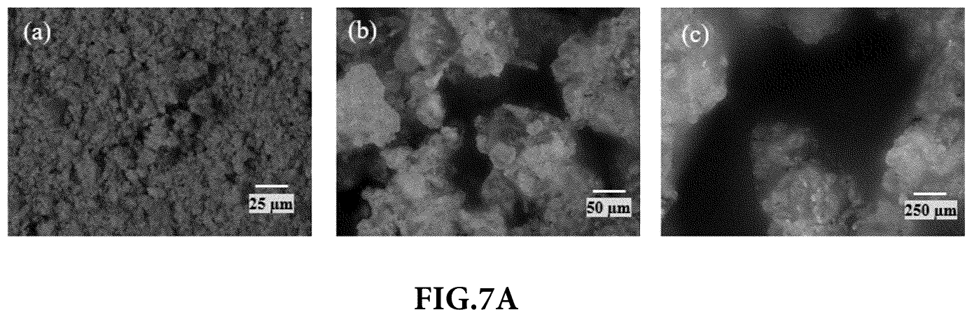

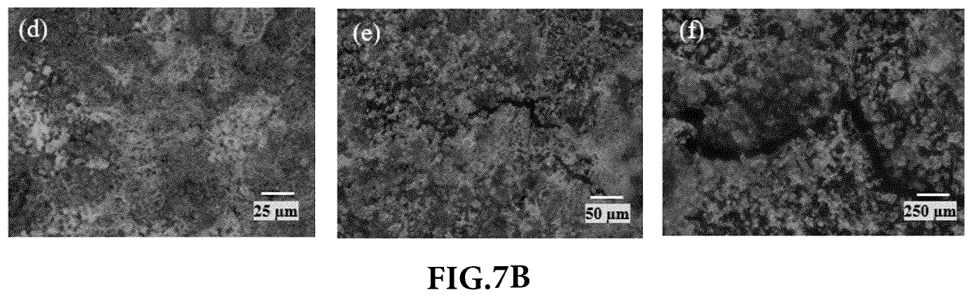

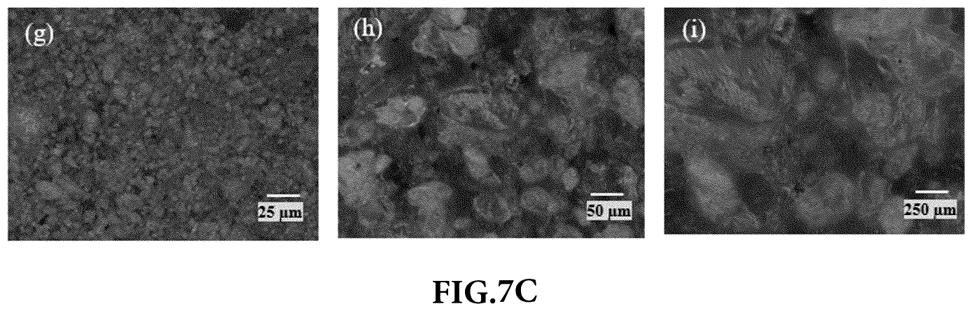

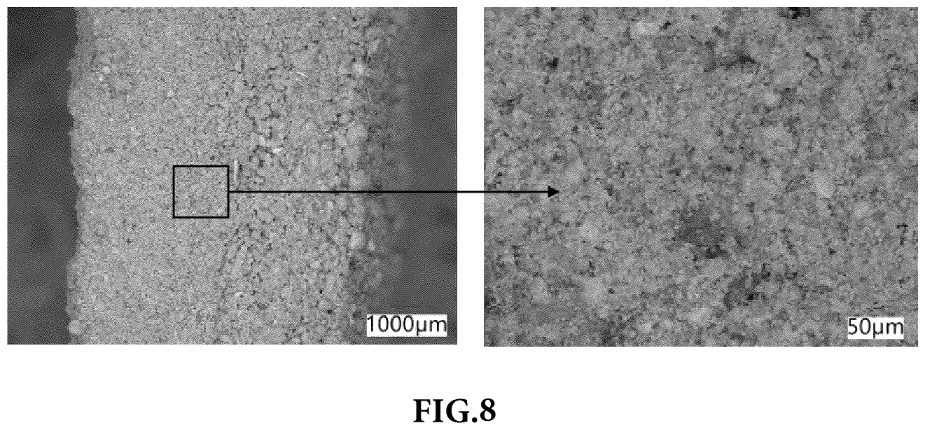

FIG. 7A-7C illustrates the surface morphology of dust samples treated with distilled water, 10% wt. NaCl, and 1% wt. RASH, captured at 250 μm, 50 μm, and 25 μm scales. The surface treated with distilled water (FIG. 7A) indicated insufficient soil particle binding, with notable pores between particles. This lack of binding creates a vulnerable surface, as water alone does not contribute to the sustained cohesion of soil particles. In the 10% wt. NaCl-treated sample (FIG. 7B), a layer of crystallized salt was observed, filling some of the spaces between particles. Despite this, the surface exhibited significant porosity, leading to a brittle crust. While NaCl aids in moisture retention, it fails to provide the structural integrity required for long-term dust suppression, making the surface susceptible to wind erosion. The regenerated hydrogel, on the other hand, formed a solidified film that tightly agglomerated particles of different sizes, resulting in a compact and agglomerated structure. The incorporation of RASH elevated viscosity (see section 2.1), caused the agglomeration of soil particles. This binding mechanism created a more robust surface, capable of withstanding wind-induced erosion while significantly extending the dust suppression effect. This mechanism is further supported by the cross-sectional microscopic image shown in FIG. 8, where the regenerated hydrogel visibly binds adjacent soil particles into a consolidated crust.

### 3.4 Elemental Analysis

Laser Induced Breakdown Spectroscopy (LIBS) was employed to determine the elemental composition of the dust samples treated with the RASH dust suppressant. LIBS is a technique for in-situ, non-destructive, and multi-element analysis, ideal for material and surface diagnostics. By directing a high-intensity pulsed laser onto the sample, LIBS generates a plasma, and the resulting emission is spectrally analyzed to determine the elemental composition of the material (Retterath et al., 2024). One of the key benefits of LIBS is its ability to perform depth profiling by drilling into the material without requiring complex sample preparation. This feature makes it well-suited for the analysis of both surface and subsurface regions.

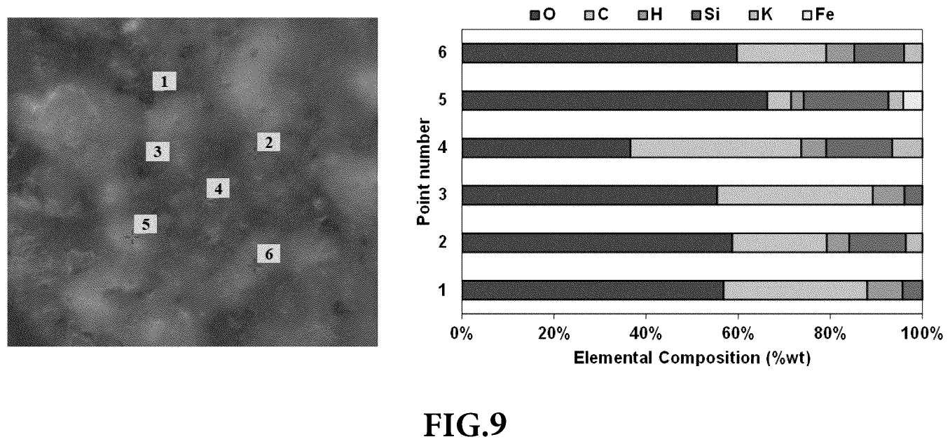

FIG. 9 illustrates the elemental composition of 1% wt. RASH-treated dust, examined at six different locations on the surface. The analysis predominantly detected elements, including oxygen, carbon, and hydrogen, which are the essential components of organic compounds found in corn starch. The presence of these elements confirms the formation of a crust rich in dried hydrogel on the dust particles. In addition, trace amounts of silicon (Si), potassium (K), and iron (Fe) were also detected, which are found in natural soils (Focus et al., 2021). No toxic heavy metals were detected on the treated surface, confirming the environmentally friendly nature of RASH.

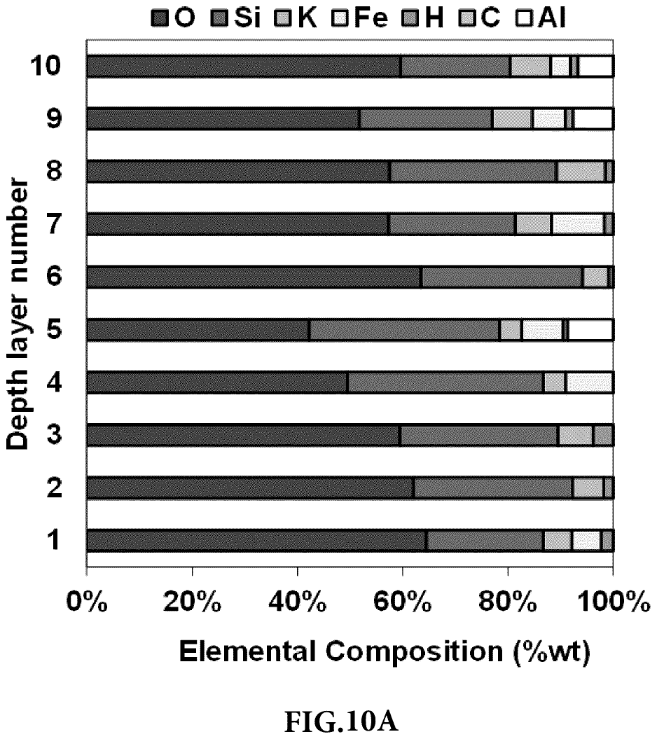

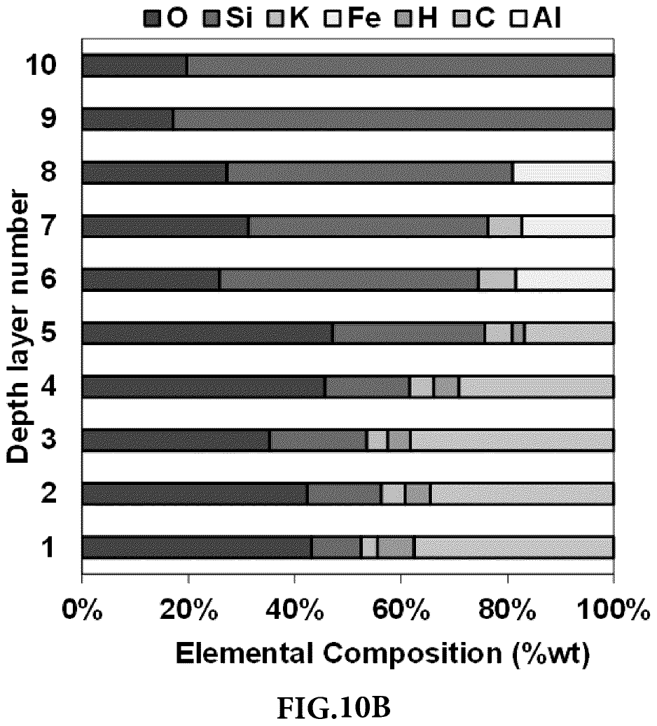

The depth profiling technique in LIBS involves irradiating multiple laser pulses at the same position on the surface of the target, allowing for the analysis of elemental composition along the depth direction from the surface to the interior (Quackatz et al., 2024). RASH-treated and untreated dust samples were subjected to a drilling mode for depth profiling, resulting in ten layers with an approximate depth of 10 micrometers for each layer. FIG. 10A-10B present non-limiting, exemplary results of the elemental composition analysis for untreated and 1% wt. RASH-treated samples, respectively. A significantly higher concentration of carbon and hydrogen was found within the first four layers of the treated samples. Without wishing to be bound by theory, this observation is indicative of the effective penetration of the RASH into the soil.

### Tests to Determine the Dust Suppression Efficiency of the Hydrogels in Lab.

4.1 in-Lab Portable In-Situ Wind Erosion Lab Test

Wind erosion poses substantial environmental challenges, particularly in regions with exposed soil such as construction sites and unpaved roads. A major concern is PM10 which is strictly regulated under national ambient air quality standards due to its adverse effects on human health and the environment (Vahlsing and Smith, 2012).

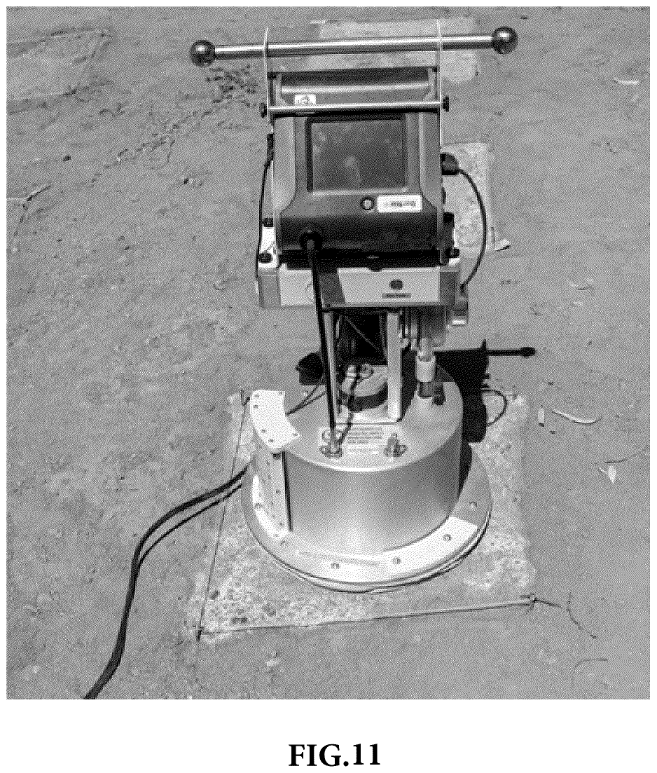

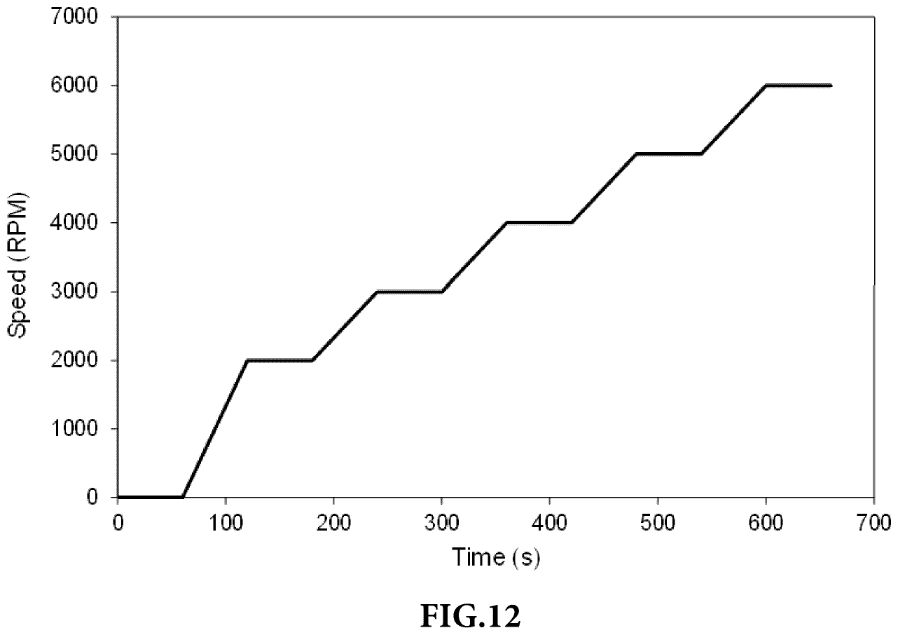

Traditionally, wind tunnels were used as the standard method for assessing dust emissions by simulating atmospheric boundary conditions. However, their large size, complexity, need for flat terrain, and extensive labor make field deployment challenging. To overcome these limitations, the Portable in-situ Wind Erosion Lab (PI-SWERL) was utilized in this study as a reliable method and is shown in FIG. 11. Unlike traditional wind tunnels, the PI-SWERL is compact and easy to deploy, allowing for rapid and cost-effective dust emission measurements in both laboratory and field environments (Sweeney et al., 2008). The PI-SWERL operates by placing an open-bottom chamber over the soil, where a rotating annular ring applies controlled wind shear. It measures larger particles using optical sensors, while a DustTrak™ sensor monitors the concentration of smaller dust particles, including PM10 (Woolley, 2023). The test utilizes a series of cycles with increasing wind shear levels up to the device's limit, as shown in FIG. 12. The wind shear in the PI-SWERL test is applied in an annular manner, which is quantified in terms of friction velocity of the wind on the soil surface according to the following equation:

$${u}_{*} = {C}_{1} {{α}^{4} ( RPM )}^{\frac{{C}_{2}}{α}} \qquad ( 1 )$$

where C_1 and C_2 are constants, a is the surface roughness factor, and RPM is the rotating speed of the annular blade in rotations per minute (Woolley, 2023).

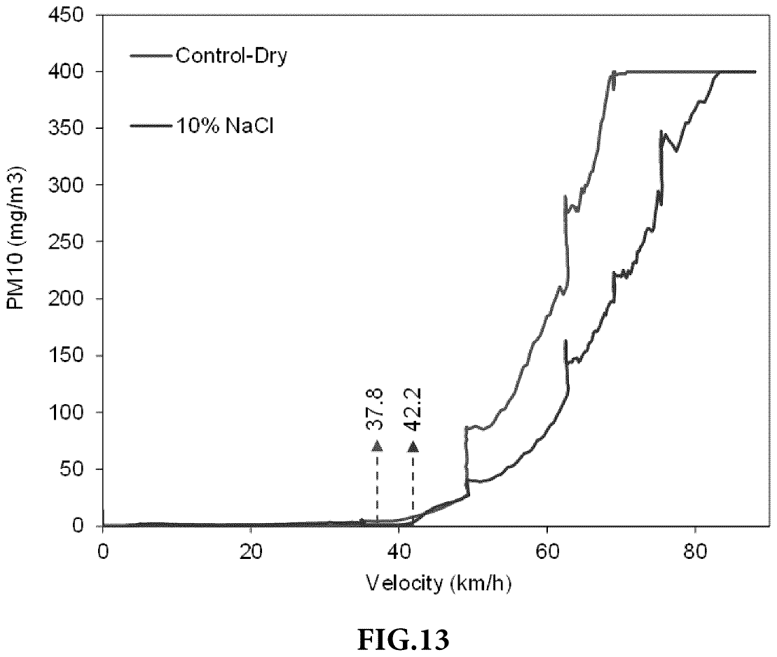

The samples of water-treated (wet control and dry control), salt-treated, and RASH-treated were prepared in commercial round pans with a diameter of 22.9 cm and a depth of 3.8 cm. Various weight concentrations of 0.5%, 1%, 2%, and 3% (wt. RASH powder) were utilized as dust suppressants. PI-SWERL testing was conducted on the samples 48 hours after the initial application of the various dust suppressants, excluding the wet control. For the wet control, the PI-SWERL test was performed immediately after application while the surface was wet. A surface roughness factor of 0.98 was assumed for the treated soil surfaces, following the guidelines (Etyemezian et al., 2014). FIG. 13 illustrates the PM10 concentration at varying wind velocities, comparing the dust suppression performance of salt-treated samples against the control, 48 hours after application. The threshold detachment velocity, defined as the velocity at which a rapid rise in PM10 concentration is first observed, was approximately 42.2 km/h for salt-treated samples and 37.8 km/h for water-treated samples (see FIG. 13). The higher detachment velocity of the salt-treated samples indicates enhanced resistance to dust emission compared to the untreated control (Woolley, 2023).

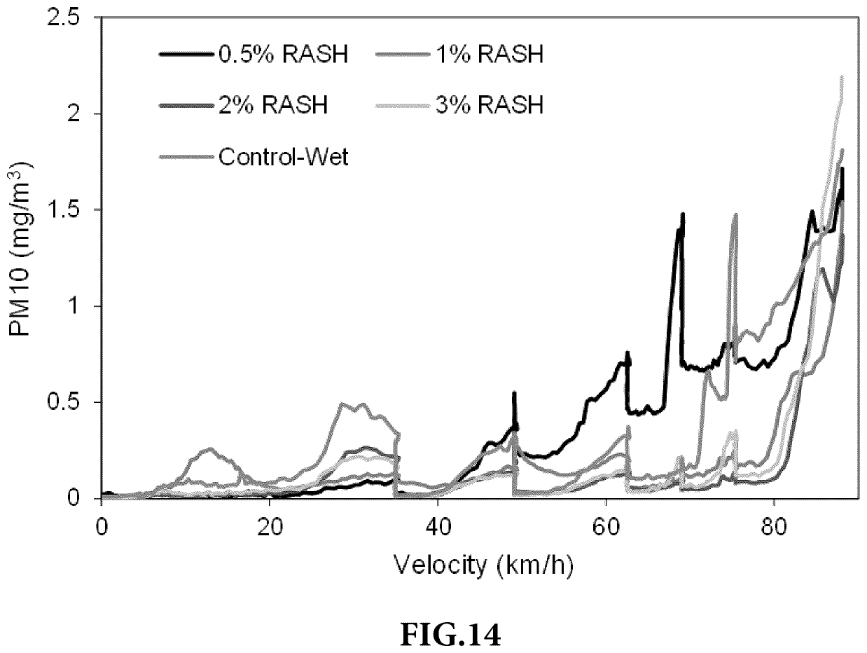

To assess the efficiency of varying weight concentrations of RASH-treated samples, FIG. 14 presents a comparison among the most effective treatments. The results indicate that the 1% wt. and 2% wt. RASH concentrations demonstrated superior performance, exhibiting minimal particle detachment from the surface tested (threshold detachment velocity >90 km/h) and outpacing the performance of the control wet solution. Notably, RASH-treated samples were evaluated 48 hours after drying, while the wet control was tested immediately after application, highlighting the efficiency of the RASH treatment.

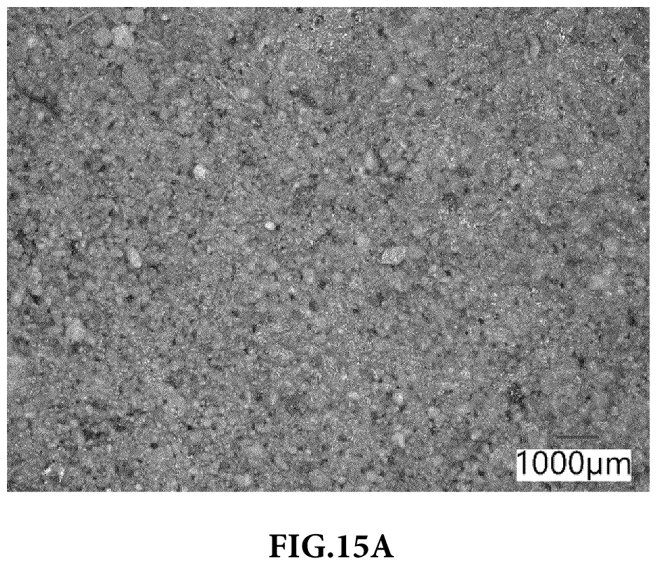

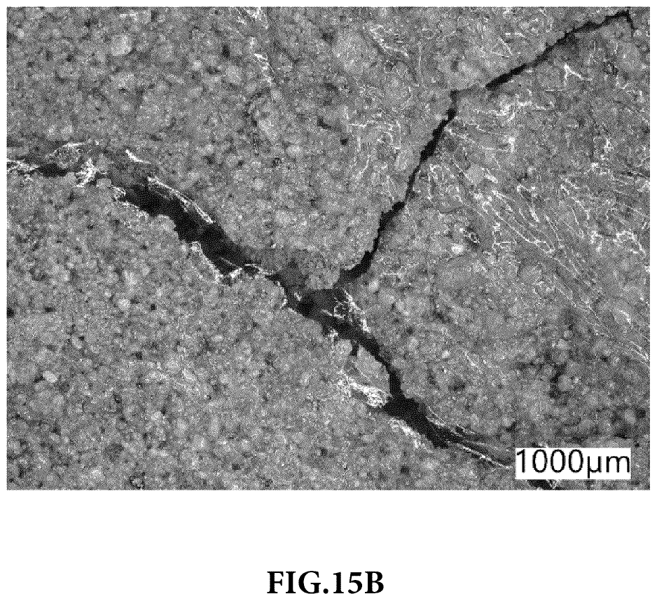

In addition to performance trends, visual inspection after drying revealed that higher concentrations of RASH (3% wt.) tended to exhibit localized drying shrinkage and visible cracks. FIG. 15A-15B compares 1% and 3% RASH-treated surfaces, highlighting the crack formation at higher concentrations. The increased viscosity of higher RASH percentages made the spraying process more challenging, impacting uniform application.

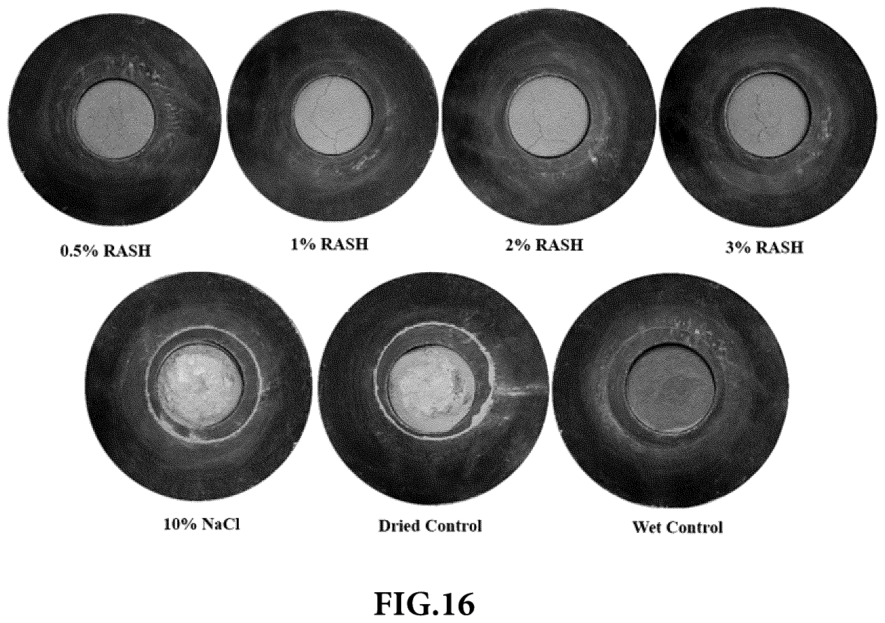

FIG. 16 shows the appearance of treated in-lab samples after the PI-SWERL test. There is no discernible difference in the surface between the pre- and post-test RASH-treated pans, indicating effective dust suppression. The RASH-treated specimens formed a soil crust that effectively bound fine soil particles together. In contrast, the salt-treated and water-treated surfaces showed considerable particle detachment. Despite its hygroscopic nature, salt is inefficient as a dust suppressant in arid climates. It forms a crust that quickly evaporates and is prone to breaking under high wind conditions.

### 4.2 Crust Strength Measurement

Crust strength is crucial for resisting wind erosion, especially in arid and semi-arid regions where soil is susceptible to wind erosion. To evaluate the strength of soil crust, several methods have been developed, including vane shear tests (Zhong et al., 2023), cone penetration tests (CPT) (Robinson et al., 2021), and flat-nose penetration tests (Yankelevsky et al., 2023). The vane shear test measures the in-situ shear strength of soils, offering insights into their resistance to deformation. In contrast, the cone penetration test (CPT) assesses subsurface resistance by profiling soil properties at different depths. The flat-nose penetration test, however, directly quantifies the surface strength of the soil crust.

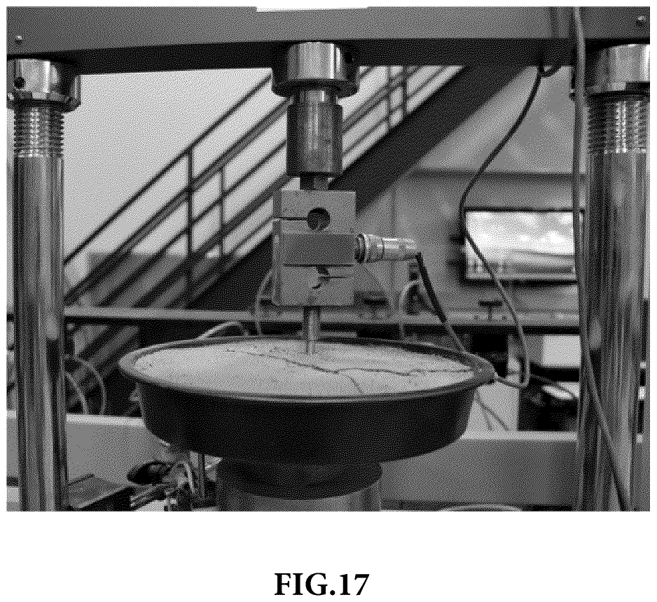

Given the significance of crust strength in mitigating wind erosion, the flat-nose penetration test is the most suitable method for this study. Note that the flat-nose penetrometer is superior to the needle penetrometer, as it distributes the load over a larger surface area, impacting multiple soil grains, whereas the needle penetrometer applies the load to only a few grains, potentially resulting in less reliable measurements of crust strength (Rice et al., 1996). The flat-nose penetration test utilizes a 6.4 mm diameter flat-nose cylindrical probe attached to the loading piston of a universal testing machine (see FIG. 17). The probe penetrates the specimen at a constant rate of 1.3 mm/min, measuring the normal force exerted on the crust and the resulting vertical deformation. Different concentrations of RASH, ranging from 0.5% to 3% by weight, were used and compared with the water-treated control sample. The crust strength tests were conducted 48 hours post-application, with each concentration undergoing three trials to ensure representative results.

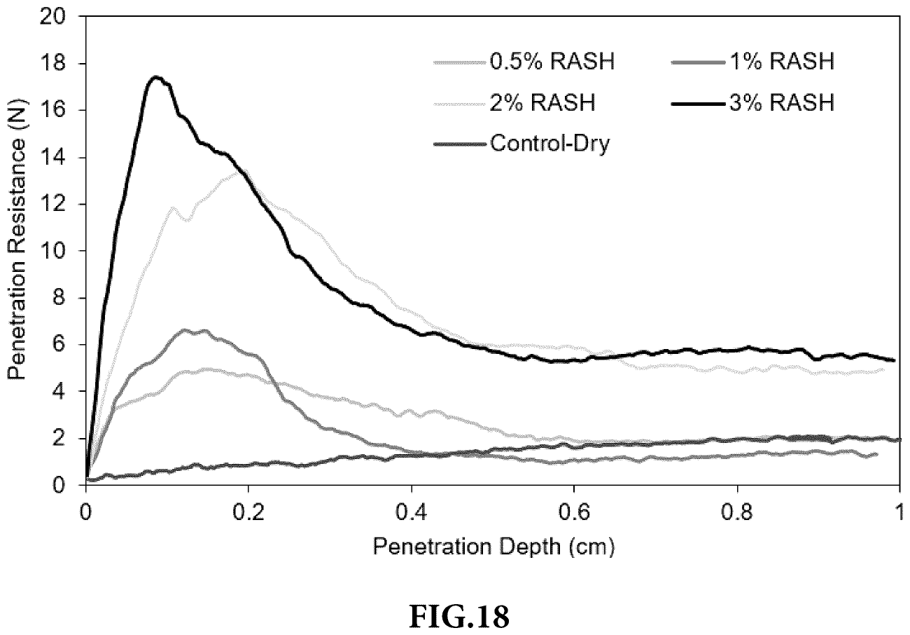

FIG. 18 shows the results of the penetration test for RASH-treated surfaces compared with a water-treated sample. The peak penetration resistance force of the water-treated sample was measured at 1.63 N, while RASH-treated samples demonstrated significantly higher peak penetration resistance values of 4.81 N for 0.5% wt. RASH, 6.58 N for 1% wt. RASH, 13.24 N for 2% wt. RASH, and 17.38 N for 3% wt. RASH concentrations. Without wishing to be bound by theory, in some embodiments substantial improvement in penetration resistance can be attributed to the formation of the crust created by the regenerated hydrogel, which binds the soil particles together and functions as an effective dust suppressant in wind-prone regions.

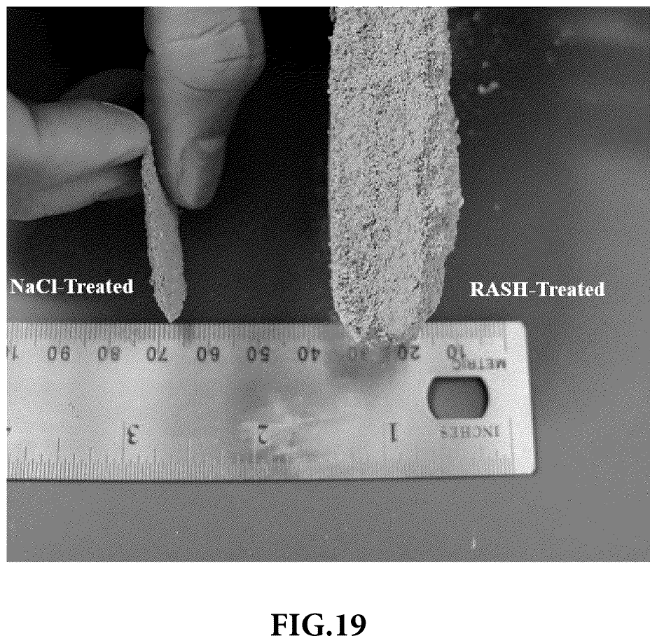

Following the penetration tests, test specimens were collected to characterize the thickness of the soil crust. This was accomplished by scraping the surface layer of specimens and extracting intact pieces of soil crust from the uppermost layer (Woolley, 2023). The dimensions of these intact crust samples were measured using calipers to ensure precision. The average crust thickness was derived from three trial samples, with five measurements taken at different locations on each sample, and the results are presented in Table 4. Notably, the 1% wt. RASH-treated samples exhibited the greatest crust thickness, striking a balance between effective penetration and medium viscosity, while providing adequate structural integrity. Conversely, the increase in viscosity observed with the 3% wt. RASH treatment resulted in a decrease in crust thickness, indicating an inability to penetrate deeper layers and adequately fill the finer pores. In contrast, the NaCl-treated samples exhibited the formation of a brittle crust layer, indicating a lower level of stability. This fragility underscores the importance of carefully considering treatment composition to achieve ideal soil crust formation. FIG. 19 visually compares the crust thickness between NaCl-treated and RASH-treated dust samples. The RASH-treated samples developed a significantly more robust thicker crust, indicating sustainable stability and effectiveness.

TABLE 4
Crust thickness measurements based on three trial
samples, with five measurement points per sample,
for RASH-treated and NaCl-treated surfaces

| | 10% wt. | 0.5% wt. | 1% wt. | 2% wt. | 3% wt. |
|---|---|---|---|---|---|
| | NaCl | RASH | RASH | RASH | RASH |
| Crust thickness (mm) | 1.71 | 16.12 | 17.11 | 17.03 | 16.85 |
| Standard error | 0.02 | 0.11 | 0.10 | 0.08 | 0.03 |
| of the mean (SEM) | | | | | |

### 5. Field Studies

To scale up the application of the hydrogels as a dust mitigation technique, a comprehensive field trial was conducted at a construction site in Tempe, Arizona. The efficiency of various treatments, including 1% wt. RASH, and 10% wt. NaCl was compared to a control group treated with water. The 1% wt. RASH concentration was chosen as the ideal concentration based on lab results (see section 3). Wind erosion resistance was assessed using the PI-SWERL device at the end of 2-, 5-, 10-, and 20-days post-application. This study was performed on two distinct soil types, fin sand (Site A) and well-graded sand with gravel (Site B), to capture the variability in dust generation potential cross typical construction environments. Treatments were applied under the hot and dry conditions of the Arizona summer to evaluate long-term performance under realistic climatic stress. PM10 concentration data collected from PI-SWERL testing served as the primary metric for dust emission.

### 5.1 Field Site Characteristics

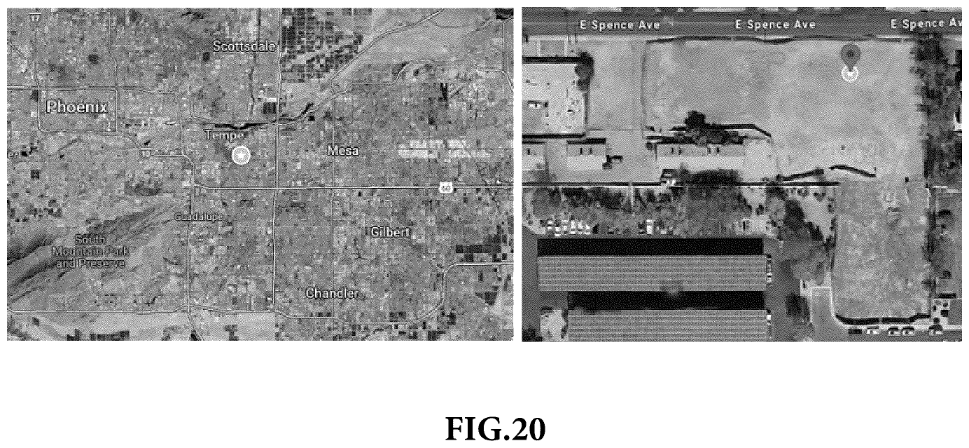

The field trial was conducted at an inactive construction site in Tempe, Arizona, as illustrated in FIG. 20. This site comprises two distinct soil covers: one predominantly composed of fine sand (Site A) and the other characterized by gravel (Site B). Soil samples were collected from designated treatment plots at both sites, and particle size distribution analysis was then performed using standard sieve analysis methods.

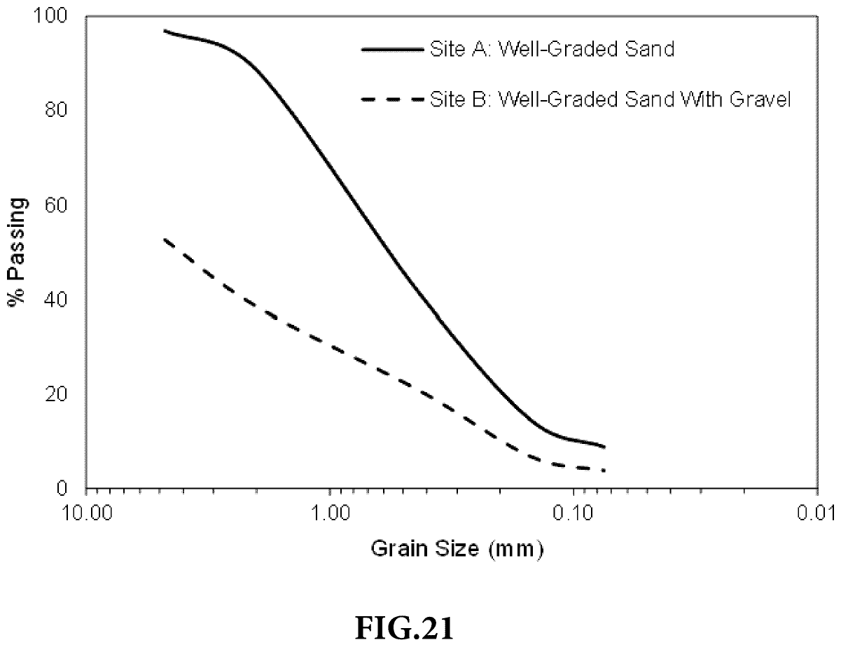

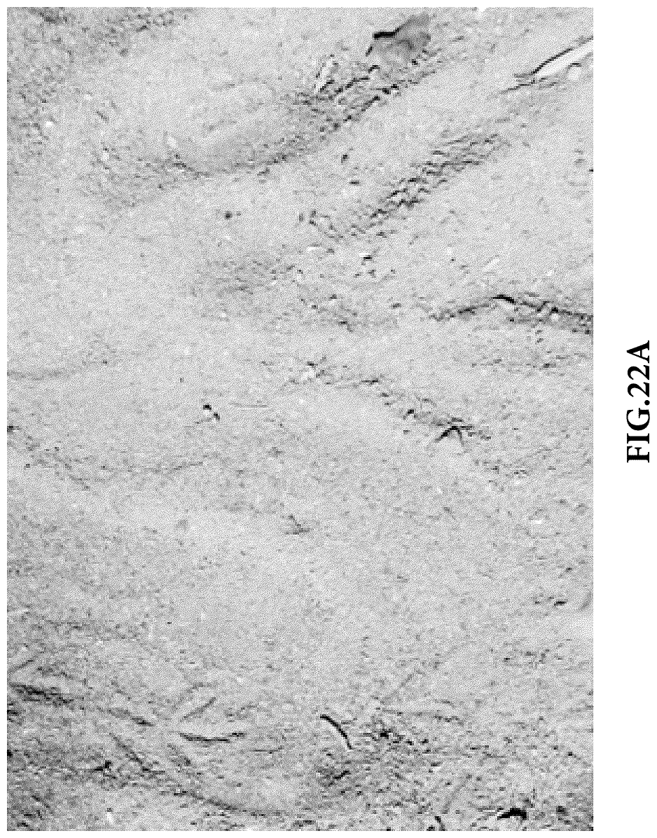

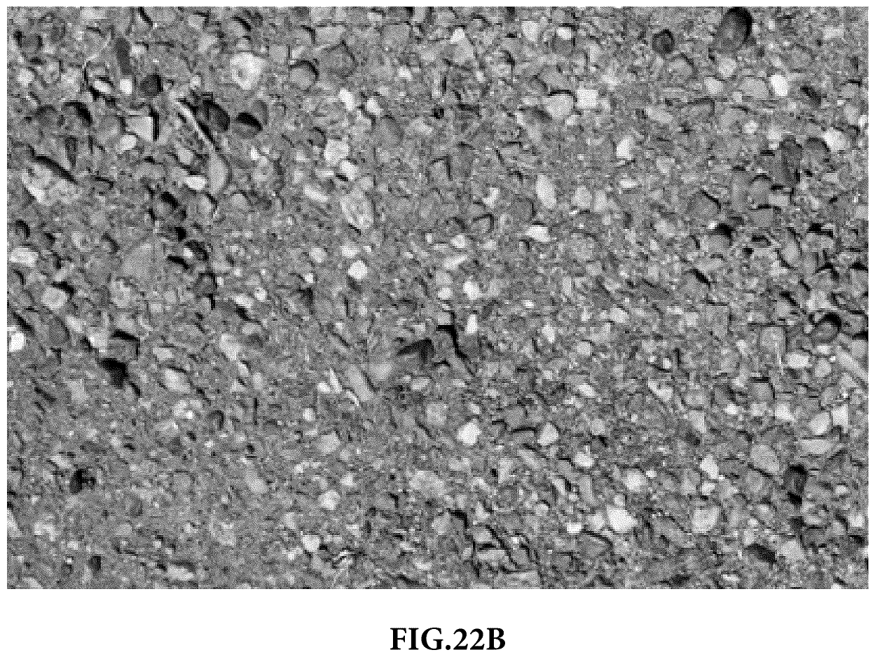

The particle size distribution of the soil is presented in FIG. 21. According to the Unified Soil Classification System (USCS) (Soil and Rock, 2017), Site A has well-graded sand, while Site B has well-graded sand with gravel. Detailed results of the sieve analysis are summarized in Table 5, and the visual characteristics of soil at each site are shown in FIG. 22A-22B. Site A, dominated by fine sand, presents a higher potential for dust generation, making it an ideal candidate for testing dust mitigation strategies. Conversely, Site B, with its well-graded sand with gravel, serves as a better representative of an unpaved area, providing insights into the performance of the RASH treatment on gravel roads.

TABLE 5
Results of sieve analysis for the construction sites

| | Gravel | Sand | Fines | | Coefficient of | Coefficient of |
|---|---|---|---|---|---|---|
| | (%) | (%) | (%) | D₅₀(mm) | Uniformity (Cᵤ) | Curvature (C_{c}) |
| Site A | 47.44 | 48.70 | 3.86 | 4.25 | 22.27 | 1.53 |
| Site B | 3.10 | 88.04 | 8.86 | 0.72 | 11.66 | 1.03 |

### 5.2 Plot Treatment

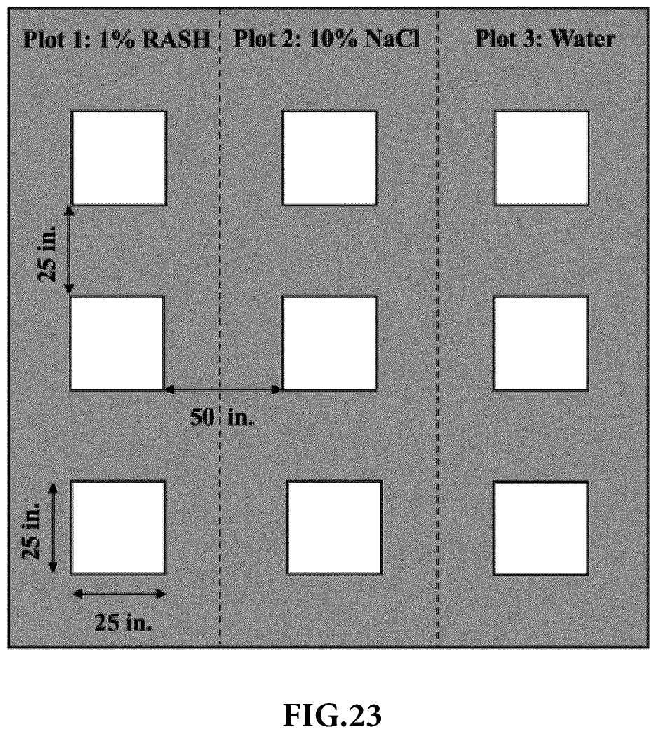

Three test plots were established at each construction site, including those treated with 1% wt. RASH, 10% wt. NaCl, and a control group treated with water. FIG. 23 depicts the layout configuration of these three test plots. Each plot comprises three squares, each with a side length of 25 inches, and a spacing of 25 inches between squares to facilitate sampling and visual observations.

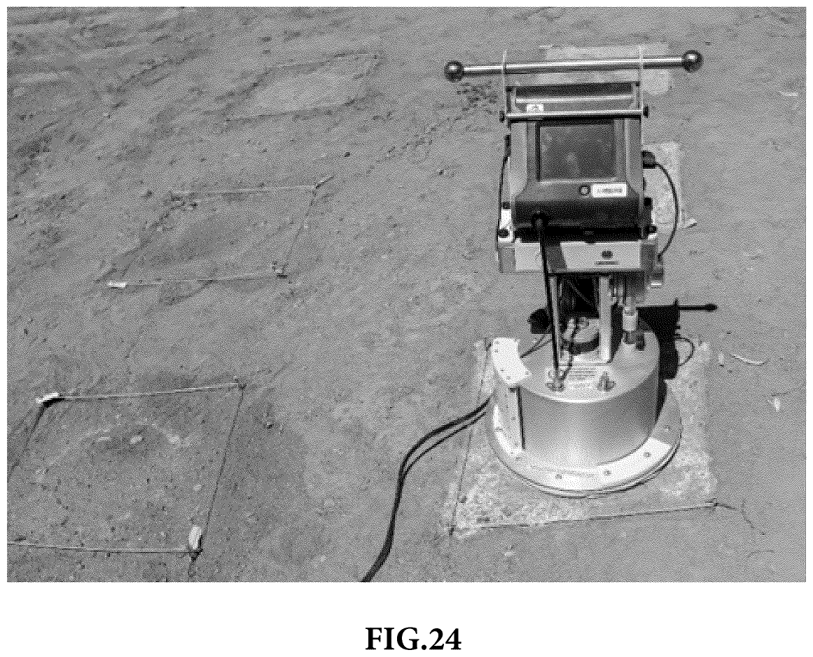

The dust suppressants were applied to each plot using a pump sprayer at a consistent application rate of 2.5 liters/m², (Woolley, 2023) for adequate coverage in similar applications. Field dust measurements were performed with the PI-SWERL 2-, 5-, 10-, and, 20-days post-application to evaluate the treatments over a longer period when compared to in-lab tests. It is noteworthy that the applications occurred during the daytime heat of June and July in Arizona's arid climate, with an average daily temperature around 39° C. and relative humidity approximately 23% throughout the 20-day evaluation period. FIG. 24 illustrates the dust measurements recorded at Site A using the PI-SWERL device 48 hours after treatment.

### 5.3 Site A: Dust Measurements

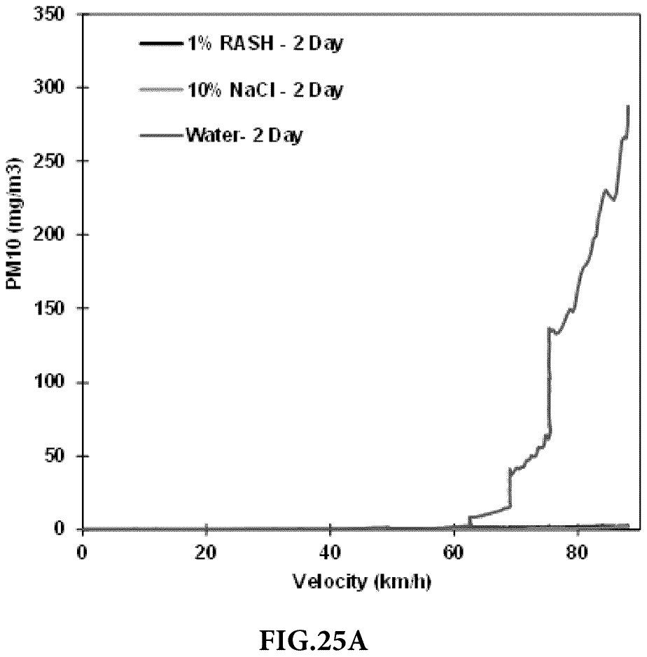

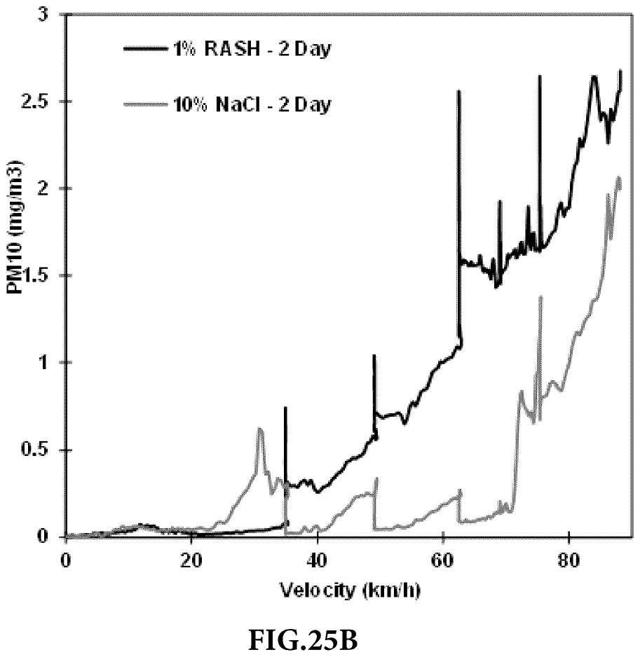

Site A, dominated by fine sand, exhibited a prominent crust on the ground surface across all treated test plots. FIG. 25A shows the PM10 concentration results at various wind velocities, recorded 48 hours after the application of the dust suppressants. The water-treated surface was dried prior to testing, and substantial particle detachment was observed when wind velocities surpassed 57.6 km/h. To better compare the efficiency of each product, FIG. 25B compares the dust measurements for different dust suppressants, excluding water as the control group. Surfaces treated with 1% wt. RASH and 10% wt. NaCl exhibited substantial resilience, effectively withstanding the maximum safe wind speeds of the PI-SWERL test. The hygroscopic properties of the 10% wt. NaCl solution facilitate moisture retention, thereby reducing dust emissions, while the 1% wt. RASH forms a robust crust on the surface by agglomerating soil particles; the strong forces generated by inter-particle bonding between soil grains and regenerated hydrogel enhance soil surface cohesion and reduce vulnerability to erosion and dust generation.

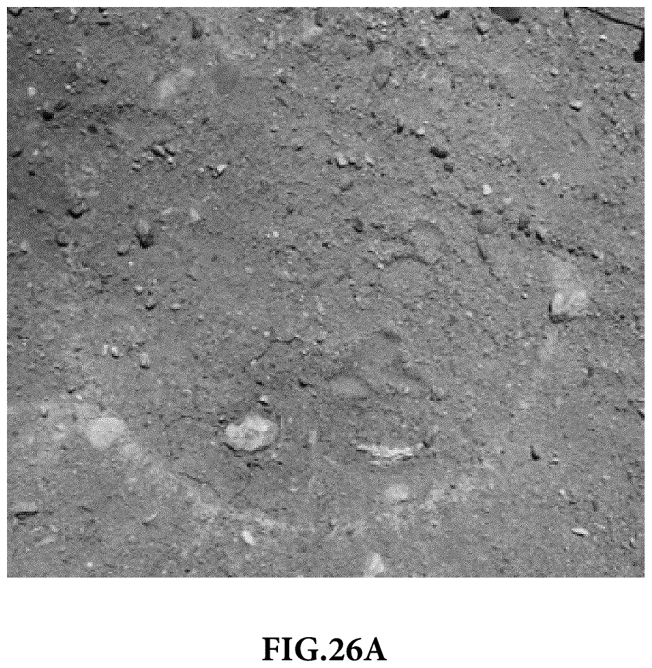

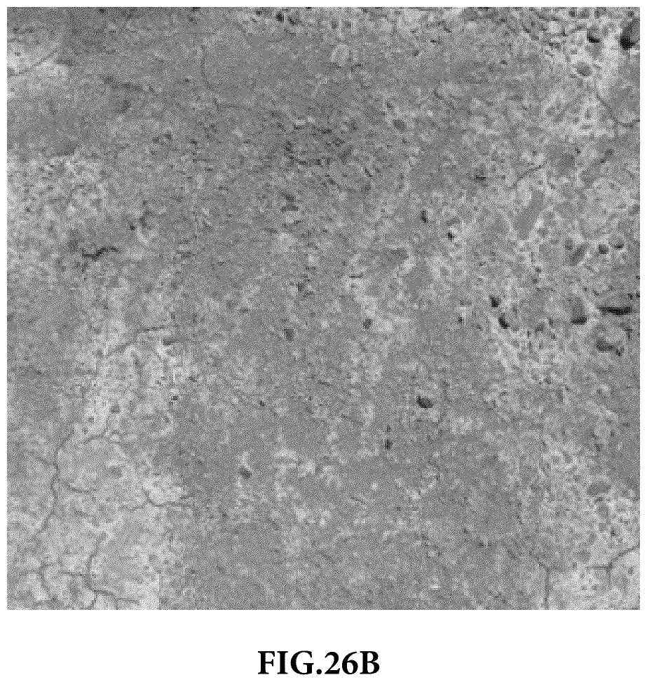

FIG. 26A-26B shows the appearance of the treated surfaces 48 hours after treatment. No significant detachment is observed in RASH-treated cases after the PI-SWERL test, indicating the general dust suppression efficiency. The presence of some dust in FIG. 26A is due to particles adhering to the rubber collar of the PI-SWERL device, rather than indicating detachment from the surface. Additionally, the white precipitate observed on the soil surface in the 10% NaCl-treated plot is due to the salt's presence, which aids in moisture retention.

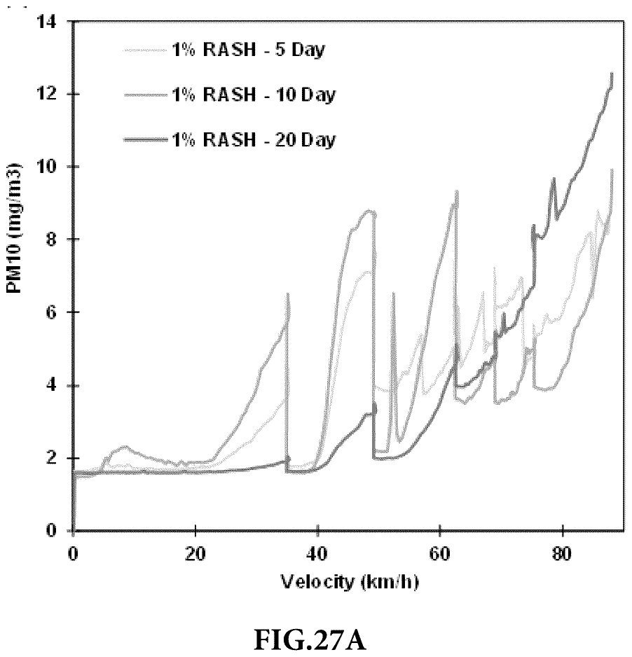

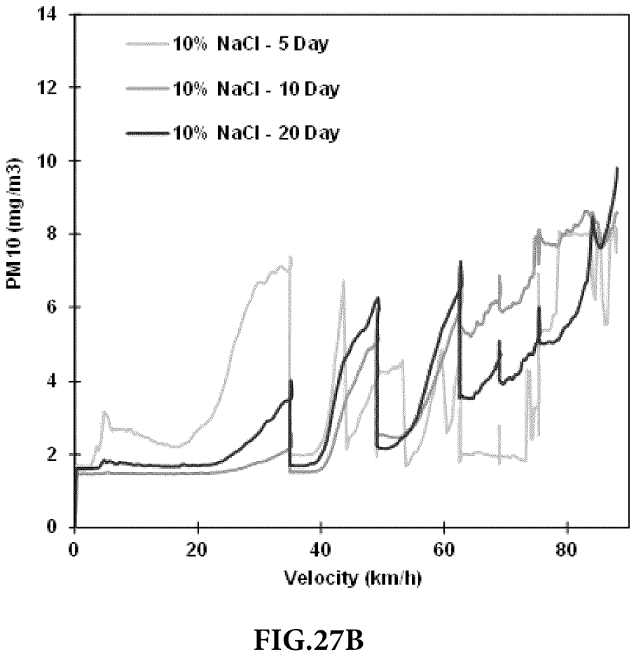

To evaluate the long-term performance of each dust suppressant, PM10 measurements were conducted after 5, 10, and 20 days following the application of the treatments to the soil surface. FIG. 27A-27B illustrates the results for the 1% wt. RASH and 10% wt. NaCl treatments. This study reveals that the maximum detectable PM10 concentration after 20 days remains as low as 12 mg/m³ for both treatments. This low concentration underscores the long-term efficacy of these dust suppressants, even under the severe, arid conditions and intense UV exposure prevalent in Arizona. For the 10% NaCl treatment, the salt not only retains moisture in the soil but also penetrates into the pores, filling spaces and cracks. The sustained low PM10 levels with 1% wt. RASH can be attributed to the strong inter-particle bonding provided by regenerated hydrogel, which enhances soil cohesion. In addition to its strong performance, RASH is a biodegradable and non-corrosive material, making it a more sustainable alternative to conventional salt-based suppressants. Moreover, it does not become an additional source of dust like salt at low relative humidity conditions.

### 5.4 Site B: Dust Measurements

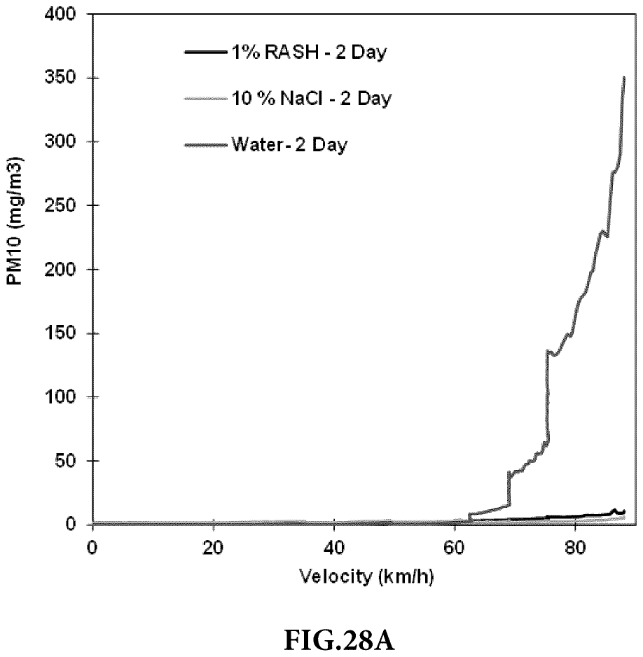

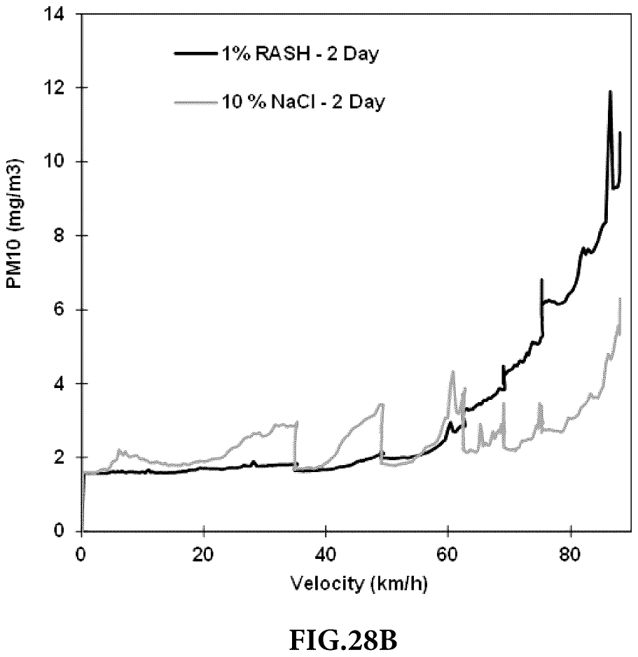

Construction Site B, characterized by its composition of well-graded sand and gravel, serves as a representative of gravel roads. FIG. 28A-28B presents the PM10 concentration results at different wind velocities 48 hours after the application of dust suppressants. The surface treated with water completely evaporated, with significant particle detachment observed at wind velocities exceeding 64.8 km/h. FIG. 28B provides a comparative analysis of the dust suppressants, excluding water as the control group.

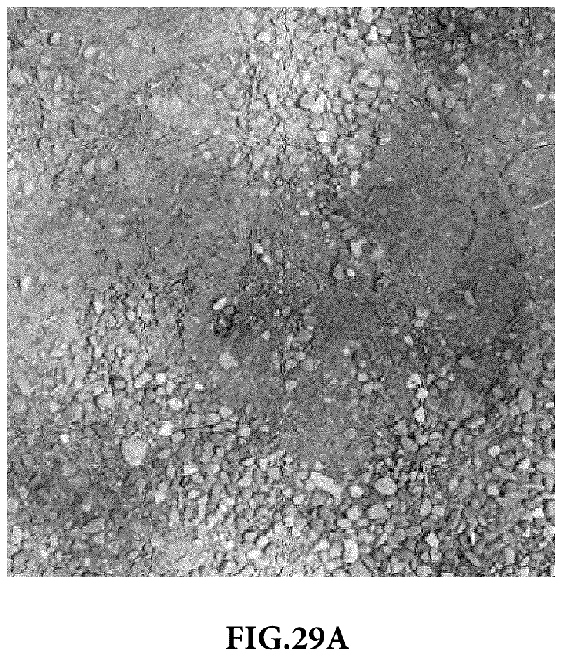

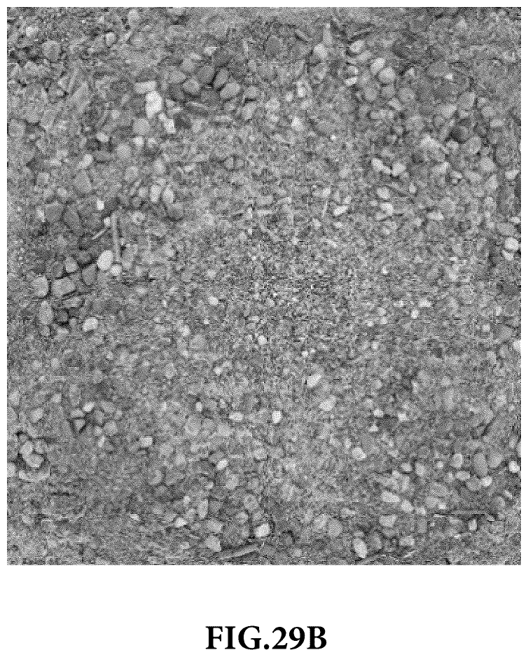

FIG. 29A-29B shows the appearance of the treated surfaces 48 hours after treatment. Some detachment is observed in both plots treated with 1% wt. RASH and 10% wt. NaCl due to the varying size of the grains.

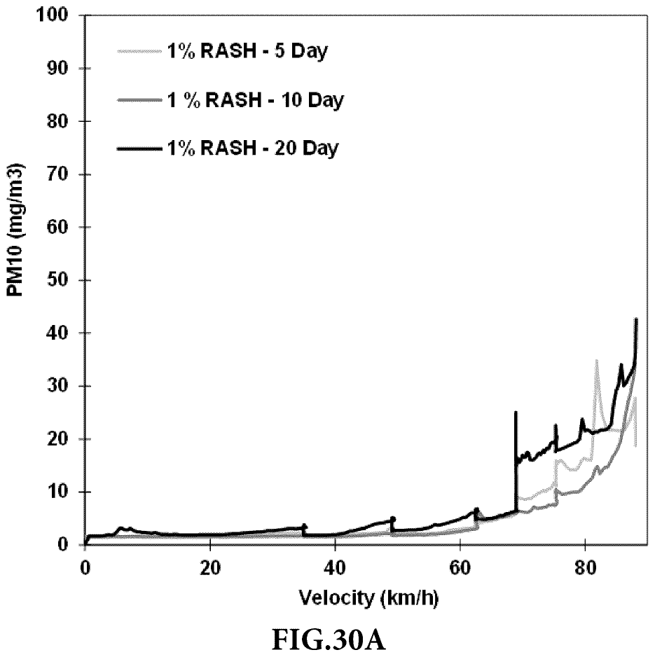

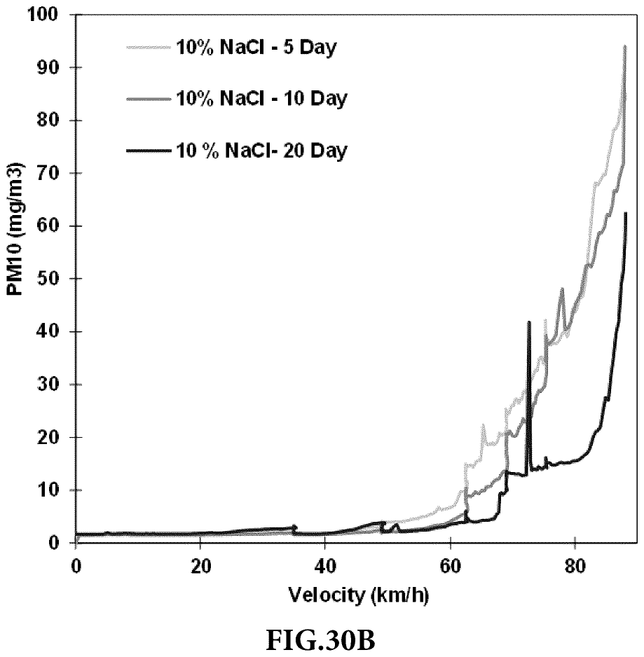

Similar to Construction Site A, long-term efficiency of each dust suppressant was evaluated 5-, 10-, and 20-days post-application. FIG. 30A-30B presents results of these measurements for 1% wt. RASH and 10% wt. NaCl treatments. After 20 days, the maximum detectable PM10 concentration was approximately 40 mg/m³ for 1% wt. RASH and 90 mg/m³ for 10% NaCl. Notably, 1% wt. RASH treatment demonstrated significantly greater effectiveness in mitigating dust compared to the 10% wt. NaCl. Without wishing to be bound by theory, this can be attributed to the hydrogel's enhanced capacity to form a stable crust through stronger inter-particle bonding. Unlike construction Site A, 10% wt. NaCl is less effective because its hygroscopic nature alone is insufficient to suppress the dust, as Site B has larger particles that have to be agglomerated for better dust suppression efficiency.

6. Non-limiting conclusions

Described herein are regenerated amylopectin starch hydrogel (RASH) compositions.

They are an effective and sustainable dust suppressant for arid environments. Under lab conditions, the application of RASH dust suppressants with varying weight fractions led to 100% wind erosion resistance at wind speeds up to 90 km/h, with especially strong performance at 1% and 2% wt. Without wishing to be bound by theory, this improvement is attributed to the agglomeration mechanism, where elevated hydrogel viscosity promotes physical binding between soil particles, forming a durable crust. At 3% wt., the higher viscosity restricted penetration and caused localized drying shrinkage and visible cracking. In contrast, 1% wt. RASH offered an balance of crust strength, penetration depth, and reduced surface defects.

RASH also showed superior long-term performance compared to traditional brine solutions in lab tests. After 48 hours, PI-SWERL tests indicated no surface detachment in RASH-treated samples at wind speeds up to 90 km/h. In contrast, brine-treated surfaces showed detachment at lower speeds (42.2 km/h). The hygroscopic nature of salt made it less effective under low-moisture conditions, while RASH maintained surface stability through its agglomeration-based mechanism. Field study validated the effectiveness of RASH, significantly reducing PM₁₀ emissions to below 2.5 mg/m³ at construction site A, dominated by fine sand. PI-SWERL tests after 20 days confirmed the long-term resilience and stability of the treated surfaces under harsh environmental conditions.

Without wishing to be bound by theory, RASH can be used across various soil types.

### REFERENCES

Ansarinejad, M., Huang, Y., Qiu, A., 2023. Impact of Fog on Vehicular Emissions and Fuel Consumption in a Mixed Traffic Flow with Autonomous Vehicles and Human-Driven Vehicles Using VISSIM Microsimulation Model, in: International Conference on Transportation and Development 2023, American Society of Civil Engineers, Austin, Texas, pp. 253-262.
Biduski, B., da Silva, W. M. F., Colussi, R., El Halal, S. L. de M., Lim, L.-T., Dias, Á. R. G., da Rosa Zavareze, E., 2018. Starch hydrogels: The influence of amylose and gelatinization method. International journal of biological macromolecules 113, 443-449.
Cheng, Y., Yuqing, H., Xiao, L., Gao, W., Kang, X., Cui, B., 2024. Impact of starch amylose and amylopectin on rheological and 3D printing properties of corn starch.
International Journal of Biological Macromolecules 278, 134403.
Da̧bski, M., Badura, I., Kycko, M., Grabarczyk, A., Matlakowska, R., Otto, J.-C., 2023. The Development of Limestone Weathering Rind in a Proglacial Environment of Hallstätter Glacier. Minerals 13, 530.
Dey, S., Kiran, R., 2022. Bio-Based Inhibitors to Mitigate Internal Corrosion in Crude Oil Pipelines 73-78.
Etyemezian, V., Gillies, J. A., Shinoda, M., Nikolich, G., King, J., Bardis, A. R., 2014. Accounting for surface roughness on measurements conducted with PI-SWERL: Evaluation of a subjective visual approach and a photogrammetric technique. Aeolian Research 13, 35-50.
Focus, E., Rwiza, M. J., Mohammed, N. K., Banzi, F. P., 2021. Health Risk Assessment of Trace Elements in Soil for People Living and Working in a Mining Area. Journal of Environmental and Public Health 2021, 1-10.
Hu, Y., Shi, L., Shan, Z., Dai, R., Chen, H., 2020. Efficient removal of atmospheric dust by a suppressant made of potato starch, polyacrylic acid and gelatin. Environ Chem Lett 18, 1701-1711.
Jalal, A., Kiran, R., 2024. Sustainable Biobased Hydrogel as an Alternative Air-Entrainment Agent in Cement-Based Materials. Journal of Materials in Civil Engineering 36, 04024342.
Kahraman, M. M., Erkayaoglu, M., 2021. A Data-Driven Approach to Control Fugitive Dust in Mine Operations. Mining, Metallurgy & Exploration 38, 549-558.
Kolawole, A. S., Iyiola, A. O., 2023. Environmental Pollution: Threats, Impact on Biodiversity, and Protection Strategies, in: Izah, S. C., Ogwu, M. C. (Eds.), Sustainable Utilization and Conservation of Africa's Biological Resources and Environment, Sustainable Development and Biodiversity. Springer Nature Singapore, Singapore, pp. 377-409.
Liang, Z., Cai, X., Hu, H., Zhang, Y., Chen, Y., Huang, Z., 2021. Synthesis of starch-based super absorbent polymer with high agglomeration and wettability for applying in road dust suppression. International Journal of Biological Macromolecules 183, 982-991.
Liu, M., Meng, Q., Niu, C., Wang, Y., Zhou, G., Xu, C., Liu, Y., 2022. Preparation and characterization of modified dual network dust suppression gel based on sodium alginate and soluble starch. Environ Sci Pollut Res 29, 69771-69784.
Liu, Y., Du, C., Yi, F., Cheng, C., Wang, M., 2024. Modified sodium alginate-based three-dimensional network hydrogel dust suppressant: Preparation, characterization, and performance. International Journal of Biological Macromolecules 274, 133408.
Liu, Y., Shao, L., Wang, W., Chen, J., Zhang, H., Yang, Y., Hu, B., 2022. Study on fugitive dust control technologies of harvesting machinery. Agriculture 12, 1038.
Manisalidis, I., Stavropoulou, E., Stavropoulos, A., Bezirtzoglou, E., 2020. Environmental and health impacts of air pollution: a review. Frontiers in public health 8, 14.
Merke, G., Hesami, M., Kiran, R., 2025. Super Absorbent Polymers (SAPs) as concentration preservers in brine deicers for enhanced ice melting capacity. J Infrastruct Preserv Resil 6, 1.
Noh, H., Lee, S., Yu, J., 2018. Identifying effective dust control measures for construction projects in Korea. Sustainability 10, 1206.
Obadi, M., Qi, Y., Xu, B., 2023. High-amylose maize starch: Structure, properties, modifications and industrial applications. Carbohydrate Polymers 299, 120185.
Organiscak, J. A., Randolph Reed, W. M., 2004. Characteristics of Fugitive Dust Generated from Unpaved Mine Haulage Roads. International Journal of Surface Mining, Reclamation and Environment 18, 236-252.
Parvej, S., Naik, D. L., Sajid, H. U., Kiran, R., Huang, Y., Thanki, N., 2021. Fugitive dust suppression in unpaved roads: State of art research review. Sustainability 13, 2399.
Patel, K. K., Shah, A. K., Latare, A. M., 2023. Effects of Hydrogel on Physical and Chemical Properties of Soil. International Journal of Plant & Soil Science 35, 129-135.
Quackatz, L., Griesche, A., Nietzke, J., Kannengiesser, T., 2024. In situ measurement of hydrogen concentration in steel using laser-induced breakdown spectroscopy (LIBS). Weld World 68, 915-923.
Retterath, L., Kohns, P., Ankerhold, G., 2024. Surface hardness imaging of a low-alloy steel using laser-induced breakdown spectroscopy. Spectrochimica Acta Part B: Atomic Spectroscopy 219, 107003.
Rice, M. A., Willetts, B. B., McEWAN, I. K., 1996. WIND EROSION OF CRUSTED SOIL SEDIMENTS. Earth Surf. Process. Landforms 21, 279-293.
Robinson, S., Brown, M. J., Matsui, H., Brennan, A., Augarde, C., Coombs, W., Cortis, M., 2021. A cone penetration test (CPT) approach to cable plough performance prediction based upon centrifuge model testing. Can. Geotech. J. 58, 1466-1477.
Schirmer, M., Jekle, M., Becker, T., 2015. Starch gelatinization and its complexity for analysis. Starch-Stärke 67, 30-41.
Soil, A. C. D.-18 on, Rock, 2017. Standard practice for classification of soils for engineering purposes (unified soil classification system) 1. ASTM international.
Sun, J., Zhou, G., Gao, D., Wei, Z., Wang, N., 2020. Preparation and performance characterization of a composite dust suppressant for preventing secondary dust in underground mine roadways. Chemical Engineering Research and Design 156, 195-208.
Sweeney, M., Etyemezian, V., Macpherson, T., Nickling, W., Gillies, J., Nikolich, G., McDonald, E., 2008. Comparison of PI-SWERL with dust emission measurements from a straight-line field wind tunnel. J. Geophys. Res. 113, 2007JF000830.
Tagrida, M., Gulzar, S., Martin-Belloso, O., Elez-Martinez, P., Soliva-Fortuny, R., 2025. Ultrasound and freeze-thaw modifications of cassava starch: Microstructure, functionality, and 3D printing potential. Food Hydrocolloids 162, 110963.
Tong, D. Q., Gill, T. E., Sprigg, W. A., Van Pelt, R. S., Baklanov, A. A., Barker, B. M., Bell, J. E., Castillo, J., Gassó, S., Gaston, C. J., Griffin, D. W., Huneeus, N., Kahn, R. A., Kuciauskas, A. P., Ladino, L. A., Li, J., Mayol-Bracero, O. L., McCotter, O. Z., Mendez-Lizaro, P. A., Mudu, P., Nickovic, S., Oyarzun, D., 2023. Health and Safety Effects of Airborne Soil Dust in Americas and Beyond. Reviews of Geophysics 61, e2021RG000763.
Tonu, T., 2023. Environmentally friendly alternatives to reduce dust emission and salt in sand and stone production industry (Master's Thesis). T. Tonu.
US EPA, O., 2016. Particulate Matter (PM) Air Quality Standards [WWW Document]. URL https://www.epa.gov/naaqs/particulate-matter-pm-air-quality-standards (accessed 11.2.24).
Vahlsing, C., Smith, K. R., 2012. Global review of national ambient air quality standards for PM10 and SO2 (24 h). Air Qual Atmos Health 5, 393-399.
Wang, R., Yu, H., Xie, Y., Li, W., Qi, H., 2024. Study on protein-polysaccharide environmental foam dust suppressant based on Maillard reaction. Journal of Molecular Liquids 410, 125644.
Wang, X., Chen, H., Shi, Y., Lin, Y., Yang, J., Li, X., 2024. Development of an eco-friendly dust suppressant based on modified guar gum: Performance analysis. Powder Technology 439, 119681.
Woolley, M. A., 2023. Laboratory and Field Evaluation of Enzyme Induced Carbonate Precipitation (EICP) for Fugitive Dust Mitigation (PhD Thesis). Arizona State University.
Xu, G., Ding, X., Kuruppu, M., Zhou, W., Biswas, W., 2018. Research and application of non-traditional chemical stabilizers on bauxite residue (red sand) dust control. Science of Total Environment 616-617, 1552-1565.
Xu, R., Yu, H., Dong, H., Ye, Y., Xie, S., 2023. Preparation and properties of modified starch-based low viscosity and high consolidation foam dust suppressant. Journal of Hazardous Materials 452, 131238.
Yang, Y., Zhao, Q., Mi, Y., 2021. Preparation and Optimum Proposal of Biological Dust Suppressant Using Straw Based on Orthogonal Test. J. Highway Transp. Res. Dev. (English Ed.) 15, 8-17.
Yankelevsky, D. Z., Feldgun, V. R., Karinski, Y. S., 2023. The false nose shape in a high velocity projectile penetration into dry sand. International Journal of Impact Engineering 177, 104492.
Zhang, L., Zhao, J., Li, F., Jiao, X., Zhang, Y., Yang, B., Li, Q., 2024. Insight to starch retrogradation through fine structure models: A review. International Journal of Biological Macromolecules 273, 132765.
Zhang YunYi, Z. Y., Wu Wei, W. W., Liu HongBin, L. H., 2019. Factors affecting variations of soil pH in different horizons in hilly regions.
Zhong, J., Wang, S., Qu, T., 2023. Undrained vane shear strength of sand-foam mixtures subjected to different shear rates. Journal of Rock Mechanics and Geotechnical Engineering 15, 1591-1602.
Zhu, Y., Cui, Y., Shan, Z., Dai, R., Shi, L., Chen, H., 2021. Fabrication and characterization of a multi-functional and environmentally-friendly starch/organo-bentonite composite liquid dust suppressant. Powder Technology 391, 532-543.

### Example 2

### Biobased Hydrogel Powder for Dust Suppression

### Non-Limiting Brief Summary

Fugitive dust is both an environmental and health concern to communities that inhibit arid and semi-arid regions in the US. The overall objective of this research is to synthesize an environmentally friendly and effective dust suppressant that can be used in a wide range of weather conditions. In this invention, we prepared a hydrogel from a specific type of corn starch and crystallized this hydrogel into a powder. This powder occupies less volume and can be used to regenerate the hydrogel when mixed appropriately with water regenerating the hydrogel. This hydrogel, when sprayed on soil surface at a specific dosage can suppress dust very efficiently even when the relative humidity is low, and the temperatures are high. This product works because of its excellent water absorption capacity and agglomeration of dust particles. This product is 100% biobased and can suppress dust on agricultural lands, construction sites, coal mines, dirt roads, fairgrounds, etc. The dust suppression efficiency of this new product has been demonstrated in both the lab and field settings.

### Introduction

Airborne dust emission has always imposed adverse effects on human health (e.g., respiratory problems, and cardiovascular issues) and the surrounding environment (e.g., contamination of water bodies and degradation of vegetation). A commonly used short-term method to mitigate airborne dust is spraying water on the soil surface. As the water evaporates and the surface dries, a thin and brittle crust is formed, providing only temporary relief. Chloride salts including Sodium Chloride (NaCl), Calcium Chloride (CaCl2)), and Magnesium Chloride (MgCl2) are other widely adapted products that work because of their hygroscopic nature. However, chloride-based dust suppressants pose major concerns including soil and water contamination, corrosion of civil infrastructure, and degradation of agricultural products.

Synthetic and biobased polymers are also used for dust suppression. Biobased polymers are made from corn starch, guar gum, chitosan, lignosulfonate, etc. The existing biobased polymers are expensive owing to their synthesis process and their dust suppression efficiency over an extended period is not investigated.

We synthesized a cost-effective biobased hydrogel as a sustainable dust mitigation product without any further risk of biohazard contamination. This hydrogel is made of corn starch which is cheap, abundant, and environmentally-friendly. The high-water absorption capacity combined with exceptional agglomeration efficiency of this material provides a durable crust with high strength that can resist wind erosion under various environmental conditions. The preliminary field tests of this hydrogel are conducted on ASU campus during the 2024 summer season when the temperatures are above 100° F. Our results indicate superior performance of these bio hydrogels highlighting application in addressing fugitive dust issues in severe environmental conditions for a prolonged period.

### Non-Limiting Description

The present invention involves the synthesis of corn-based hydrogel crystals with high agglomeration efficiency and enhanced water absorption capacity. Generally, corn starch is composed of two glucose polymers, amylose and amylopectin. Amylose is a linear polymer made up solely of α-1,4 glycosidic bonds, whereas amylopectin is a highly branched polysaccharide made up of α-1,4 linked glucose with α-1.6 connections at the branch point. The water-absorption capability along with the mechanical strength of the corn-based hydrogel are influenced by the proportions of amorphous amylose and crystalline amylopectin. While higher proportion of amylose would yield a strong gel, the starch rich in amylopectin will have better water absorption capacity. The present invention utilizes a commercially available amylopectin corn starch (ACS), composed of about 90% amylopectin which has a high molecular weight, and highly branched molecular structure.

Starch gelatinization was achieved through thermal treatment to transform the ordered structure of the starch to an amorphous state. Initially, 10 grams of cornstarch (regular/Amylopectin) were suspended in 190 mL distilled water to form a 5% solution, which was magnetically stirred for 15 minutes at 90° C. The application of heat energy causes the starch granules in the water solution to swell, releasing amylose and amylopectin. The sustained heat leads to the formation of a gel structure that includes suspended glucose particles bonded with water molecules. Subsequently, the solution was cooled to room temperature. After freezing for 24 hours at −18° C., the samples were then thawed at room temperature for 48 hours. The resultant foam is ground into a fine powder to obtain the powder.

In embodiments, the hydrogel powder was then mixed with hot water (65° C.) in different weight percentages (0.5%, 1%, 2%, 3%). The presence of heat facilitates the re-gelatinization of hydrogel to achieve the desired viscosity and dust suppression efficiency. After cooling down to room temperature, the solution was sprayed on the soil surface with application rate of 2.5 L/m².

A new biobased product was developed for use as a dust suppressant in arid climates. This product is non-toxic, and the raw materials needed to synthesize this product are abundantly available in the USA. No special equipment is necessary, and the existing tankers or de-icing vehicles can be used to apply this product. This product is compatible with chloride-based salts and the combination will produce long-lasting results. The product has a long shelf life and can be prepared on the site for immediate use. Both the in-lab and field tests are very promising, reflected as reduced particulate material entrained into the air. This product can be used in construction sites, mines, fairgrounds, agricultural fields, etc. This product requires no soil preparation and is effective 30 to 60 minutes after application.

### Non-Limiting Inventive Aspects

Green Technology: Unlike traditional chloride salts that could easily contaminate soil and water, this invention is a sustainable, and environmentally friendly material. Non-toxic: This product does not induce toxicity when eroded from the soil and is 100% biobased. No special equipment or PPE is required for its application.

Compatible with chloride salts: this product is compatible with the chloride salts and this combination can enhance the performance of this product further.

Durability: our in-lab and field tests indicate that it is possible to suppress the dust very efficiently for over 3 weeks even in low humidity environments.

Transformed an amylopectin-rich corn starch into a powdered hydrogel.

Reconstituted and added to soil as a gelatin to suppress dust.

### Non-Limiting Advantages Technology

Economical: This product will be very economical when produced in bulk when compared to other non-chloride salt products.

Made in USA: no raw materials have to be imported from abroad.

This product needs no soil preparation and is effective within 30-60 minutes after application.

This product has long shelf life

The proposed product can be a promising dust suppressant in arid climates. There are many products in the market and most of them are propitiatory mixes of chloride salts or polymers which are either non-environmentally friendly or expensive or both.

The technology is a corn starch-derived hydrogel for use as a dust suppressant in arid climates. Airborne dust emission has always imposed adverse effects on human health (e.g., respiratory problems, and cardiovascular issues) and the surrounding environment (e.g., contamination of water and degradation of vegetation). A commonly used short-term method to mitigate airborne dust is spraying water on the soil surface. As the water evaporates and the surface dries, a thin and brittle crust is formed, providing only temporary relief. Disclosed is a cost-effective biobased hydrogel as a sustainable dust mitigation product without any further risk of biohazard contamination. This hydrogel is made of corn starch which is cheap, abundant, environmentally friendly, and sustainable. Amylopectin-based corn starch has been transformed into a hydrogel-based powdered product that can be reconstituted when it is ready to be sprayed onto soil for dust suppression. The product was successfully tested on the ASU campus during the 2024 summer season. This product can be used in construction sites, mines, fairgrounds, agricultural fields, etc., that are susceptible to dust formation. This product requires no soil preparation and is effective 30 to 60 minutes after application.

### Example 3

### An Economical and Sustainable Dust Suppressant for Gravel Roads

### Synthesis and Characterization of Bio-Based Hydrogel for Dust Mitigation

Described herein is the synthesis of various bio-based hydrogels formulated for environmentally friendly dust suppressants. Four hydrogel systems were developed using naturally derived polymers: lignin-chitosan hydrogel, hydroxyethyl cellulose (HEC) hydrogel, alkali-treated starch hydrogel, and a regenerated starch-based hydrogel. Each formulation was evaluated based on ease of preparation, environmental compatibility, and suitability for field application.

The initial sections of this report describe the materials used and detail the synthesis procedures for each hydrogel type. Following this, a comparative analysis led to the selection of the regenerated amylopectin starch hydrogel (RASH) as the most practical candidate due to its bio-origin, simplicity of regeneration, and shelf stability. Additional studies focus on the regenerated starch hydrogel, outlining an exemplary regeneration protocol and providing characterizations. These tests include viscosity and pH measurements, particle size distribution, morphological observation, and elemental analysis to assess the hydrogel's performance and interaction with soil under dust-prone conditions.

### Materials

The materials used in this study included chitosan (medium molecular weight), alkali lignin, hydroxyethyl cellulose (HEC), sodium hydroxide (NaOH), glycerol, and citric acid, all of which were obtained from Sigma-Aldrich. Commercially available corn starch was used as the starch source. Distilled water was used throughout the preparation and testing procedures.

### Synthesis Process of Bio-Based Hydrogels

### Lignin-Chitosan Hydrogel

Lignin is a naturally abundant phenolic polymer that serves as a critical structural component in vascular plants. It consists roughly 25% of wood by weight and is mostly discarded or incinerated during the paper pulping process, despite its renewable origin and non-toxic nature [51,52]. Recently, alkali lignin has gained attention as a sustainable and cost-effective ionotropic cross-linker, particularly for chitosan, a biodegradable polysaccharide derived from chitin [53].

Described herein, lignin-chitosan hydrogels were synthesized through ionotropic gelation, where the electrostatic interaction between the negatively charged phenoxide groups in lignin and the positively charged ammonium groups on the chitosan backbone led to the formation of a cross-linked network. A similar strategy has been previously applied in biomedical applications for wound care [54]; however, the method was modified here to ensure compatibility with soil environments. To adjust the pH for soil health, sodium hydroxide (NaOH) was introduced during the synthesis process.

The hydrogel was prepared by dissolving 3 grams of chitosan in 300 milliliters of 3% acetic acid and stirring the mixture for about 10 minutes. Separately, 2 grams of alkali lignin were dissolved in 200 milliliters of distilled water and gradually added to the chitosan solution with continuous stirring. Following this, 100 milliliters of 0.1 M NaOH were added to initiate gelation and bring the pH closer to neutral. The pH of the resulting hydrogel was 4.78 using an Oakton PH 550 pH Meter. The gels were directly used as a bio-based dust suppressant.

### Hydroxyethyl Cellulose (HEC) Hydrogel

Hydroxyethyl cellulose (HEC) is a water-soluble, non-ionic polymer derived from cellulose, commonly used for its thickening, film-forming, and stabilizing properties. It's known for being safe, biodegradable, and compatible with a wide range of formulations [39,55]. In this work, a simple heating method was used to prepare a hydrogel from HEC without the need for any additional cross-linkers or chemical modifications.

To form the gel, 5 grams of HEC powder were dissolved in 500 milliliters of deionized water to make a 1% (w/v) solution. The solution was then heated for 10 minutes at 35° C. while being stirred continuously. During heating, the initially clear and viscous solution gradually thickened and took on a soft gel-like consistency. Heating helps disrupt the existing hydrogen bonds within and between HEC molecules, allowing the chains to move more freely and interact with surrounding water molecules. As the solution cools or stabilizes at the new temperature, the polymer chains begin to re-associate through hydrogen bonding and entanglement. These physical interactions give rise to a three-dimensional network that traps water and holds the gel structure together. Since no chemical reaction takes place, this process is considered reversible and driven purely by physical forces. The final pH of this hydrogel was 7.85 as shown in Table 6. The resultant hydrogel can be directly applied on soil surface as a dust suppressant.

### Alkali-Treated Starch

This section describes a non-limiting, exemplary room-temperature gelatinization method for starch using an alkaline system composed of sodium hydroxide (NaOH) and glycerol. Alkaline treatment is known to break the hydrogen bonds within and between starch molecules, which helps the starch granules swell and dissolve more easily [56]. While starch typically requires heat to gelatinize, previous studies have shown that certain chemical combinations can achieve similar results at room temperature. In this case, glycerol played an important role as a plasticizer, helping to prevent the starch chains from clumping back together once they're separated, which is a common issue known as retrogradation.

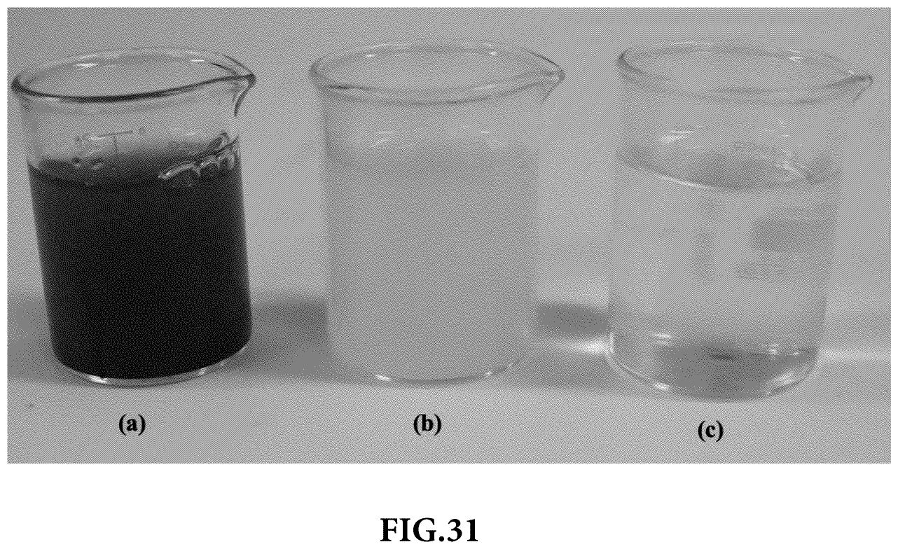

To prepare the hydrogel, 2 grams of starch were added to 98 milliliters of water, creating a 2% solution. Then, 1.5 grams of NaOH and 1 gram of glycerol were introduced, and the mixture was stirred continuously for 45 minutes. As the solution became more viscous, indicating gelatinization, 2 grams of citric acid were added to neutralize the pH, followed by another 5 minutes of stirring to ensure uniformity. The final pH was recorded as 6.95. The ease of preparation, biodegradability, and compatibility with soil make this hydrogel as a strong candidate for use in sustainable environmental solutions. A summary of the key properties of the three synthesized hydrogels is provided in Table 6, and their visual appearance is shown in FIG. 31.

TABLE 6
Summary of synthesized hydrogels in this study

| Commercial | | | | |
|---|---|---|---|---|
| Name | Hydrogel Name | Base Materials | Mechanism | pH |
| HA | Lignin-Chitosan | Chitosan, Alkali Lignin | Electrostatic interaction | 4.78 |
| | Hydrogel | | (ionotropic association) | |
| HB | HEC Hydrogel | Hydroxyethyl Cellulose | Physical gelation via H-bonding | 7.85 |
| | | | and entanglement | |
| HC | Alkali-treated | Starch, NaOH | Alkaline disruption of H-bonds | 6.95 |
| | Starch | | and chain relaxation | |

### REFERENCES CITED HEREIN

[1] Ambient (outdoor) air pollution, (n.d.). https://www.who.int/news-room/fact-sheets/detail/ambient-(outdoor)-air-quality-and-health (accessed Nov. 2, 2024).
[2] I. Manisalidis, E. Stavropoulou, A. Stavropoulos, E. Bezirtzoglou, Environmental and health impacts of air pollution: a review, Frontiers in Public Health 8 (2020) 14.
[3] C.-H. Lee, L.-W. Tang, C. T. Chang, Modeling of Fugitive Dust Emission for Construction Sand and Gravel Processing Plant, Environ. Sci. Technol. 35 (2001) 2073-2077. doi.org/10.1021/es001237y.
[4] H. Noh, S. Lee, J. Yu, Identifying effective fugitive dust control measures for construction projects in Korea, Sustainability 10 (2018) 1206.
[5] F. S. Pianalto, S. R. Yool, Monitoring fugitive dust emission sources arising from construction: a remote-sensing approach, GI Science & Remote Sensing 50 (2013) 251-270. doi.org/10.1080/15481603.2013.808517.
[6] Y. Liu, L. Shao, W. Wang, J. Chen, H. Zhang, Y. Yang, B. Hu, Study on fugitive dust control technologies of agricultural harvesting machinery, Agriculture 12 (2022) 1038.
[7] K. Saxton, D. Chandler, L. Stetler, B. Lamb, C. Claiborn, B.-H. Lee, Wind erosion and fugitive dust fluxes on agricultural lands in the Pacific Northwest, Transactions of the ASAE 43 (2000) 623-640.
[8] B. Chakradhar, Fugitive dust emissions from mining areas, Journal of Environmental Systems 31(2005). https://access.portico.org/Portico/show?viewFile=pdf&auId=pgk5sxhmhq (accessed Nov. 2, 2024).
[9] M. M. Kahraman, M. Erkayaoglu, A Data-Driven Approach to Control Fugitive Dust in Mine Operations, Mining, Metallurgy & Exploration 38 (2021) 549-558. doi.org/10.1007/s42461-020-00318-2.
[10] D. Barnes, B. Connor, Managing dust on unpaved roads and airports, Alaska University Transportation Center, 2014. https://scholarworks.alaska.edu/handle/11122/8813 (accessed Nov. 2, 2024).
[11] R. I. J. Dyck, J. J. Stukel, Fugitive dust emissions from trucks on unpaved roads, Environ. Sci. Technol. 10 (1976) 1046-1048. doi.org/10.1021/es60121a015.
[12] J. A. Organiscak, W. M. Randolph Reed, Characteristics of Fugitive Dust Generated from Unpaved Mine Haulage Roads, International Journal of Surface Mining, Reclamation and Environment 18 (2004) 236-252. doi.org/10.1080/1389526042000263333.
[13] S. Parvej, D. L. Naik, H. U. Sajid, R. Kiran, Y. Huang, N. Thanki, Fugitive dust suppression in unpaved roads: State of the art research review, Sustainability 13 (2021) 2399.
[14] G. Zhao, Y. Chen, P. K. Hopke, T. M. Holsen, S. Dhaniyala, Characteristics of traffic-induced fugitive dust from unpaved roads, Aerosol Science and Technology 51 (2017) 1324-1331. doi.org/10.1080/02786826.2017.1347251.
[15] M. Ansarinejad, Y. Huang, A. Qiu, Impact of Fog on Vehicular Emissions and Fuel Consumption in a Mixed Traffic Flow with Autonomous Vehicles (AVs) and Human-Driven Vehicles Using VISSIM Microsimulation Model, in: International Conference on Transportation and Development 2023, American Society of Civil Engineers, Austin, Texas, 2023: pp. 253-262. doi.org/10.1061/9780784484876.023.
[16] C. Vahlsing, K. R. Smith, Global review of national ambient air quality standards for PM10 and SO2 (24 h), Air Qual Atmos Health 5 (2012) 393-399. doi.org/10.1007/s11869-010-0131-2.
[17] M. A. Barrero, J. A. G. Orza, M. Cabello, L. Cantón, Categorisation of air quality monitoring stations by evaluation of PM10 variability, Science of The Total Environment 524 (2015) 225-236.
[18] K.-H. Kim, Z.-H. Shon, Long-term changes in PM10 levels in urban air in relation with air quality control efforts, Atmospheric Environment 45 (2011) 3309-3317.
[19] Fugitive Dust Control Measures and Best Practices, (n.d.).
[20] H. Jin, W. Nie, Y. Zhang, H. Wang, H. Zhang, Q. Bao, J. Yan, Development of Environmental Friendly Dust Suppressant Based on the Modification of Soybean Protein Isolate, Processes 7 (2019) 165. doi.org/10.3390/pr7030165.
[21] Y. Hu, L. Shi, Z. Shan, R. Dai, H. Chen, Efficient removal of atmospheric dust by a suppressant made of potato starch, polyacrylic acid and gelatin, Environ Chem Lett 18 (2020) 1701-1711. doi.org/10.1007/s10311-020-01025-6.
[22] S. W. Morefield, J. K. Newman, C. A. Weiss Jr, C. C. Thomas, P. G. Malone, Corrosion Inhibitive Hygroscopic Organic-Based Dust Palliatives, (2018). https://apps.dtic.mil/sti/trecms/pdf/AD1081140.pdf (accessed Nov. 2, 2024).
[23] Y. Xi, Z. Xie, Corrosion effects of magnesium chloride and sodium chloride on automobile components, Colorado Department of Transportation, Research [Branch], 2002. https://www.codot.gov/programs/research/reports/2002/magautocor.pdf (accessed Nov. 2, 2024).
[24] K. Edvardsson, Gravel Roads and Dust Suppression, Road Materials and Pavement Design 10 (2009) 439-469. doi.org/10.1080/14680629.2009.9690209.
[25] C.-M. Geilfus, Chloride in soil: From nutrient to soil pollutant, Environmental and Experimental Botany 157 (2019) 299-309.
[26] D. Q. Tong, T. E. Gill, W. A. Sprigg, R. S. Van Pelt, A. A. Baklanov, B. M. Barker, J. E. Bell, J. Castillo, S. Gassó, C. J. Gaston, D. W. Griffin, N. Huneeus, R. A. Kahn, A. P. Kuciauskas, L. A.
Ladino, J. Li, O. L. Mayol-Bracero, O. Z. McCotter, P. A. Mendez-Lizaro, P. Mudu, S. Nickovic, D. Oyarzun, J. Prospero, G. B. Raga, A. U. Raysoni, L. Ren, N. Sarafoglou, A. Sealy, Z. Sun, A. V. Vimic, Health and Safety Effects of Airborne Soil Dust in the Americas and Beyond, Reviews of Geophysics 61 (2023) e2021RG000763. doi.org/10.1029/2021RG000763.
[27] B. K. Kunz, E. E. Little, V. L. Barandino, Aquatic Toxicity of Chemical Road Dust Suppressants to Freshwater Organisms, Arch Environ Contam Toxicol 82 (2022) 294-305. doi.org/10.1007/s00244-020-00806-y.
[28] B. A. Goodrich, R. D. Koski, W. R. Jacobi, Monitoring Surface Water Chemistry Near Magnesium Chloride Dust Suppressant Treated Roads in Colorado, J of Env Quality 38 (2009) 2373-2381. doi.org/10.2134/jeq2009.0042.
[29] T. Tonu, Environmentally friendly alternatives to reduce dust emission and salt use in the sand and stone production industry, Master's Thesis, T. Tonu, 2023. https://oulurepo.oulu.fi/handle/10024/42341 (accessed Nov. 2, 2024).
[30] A. S. Kolawole, A. O. Iyiola, Environmental Pollution: Threats, Impact on Biodiversity, and Protection Strategies, in: S. C. Izah, M. C. Ogwu (Eds.), Sustainable Utilization and Conservation of Africa's Biological Resources and Environment, Springer Nature Singapore, Singapore, 2023: pp. 377-409. doi.org/10.1007/978-981-19-6974-4_14.
[31] A. Almajed, K. Lemboye, M. G. Arab, A. Alnuaim, Mitigating wind erosion of sand using biopolymer-assisted EICP technique, Soils and Foundations 60 (2020) 356-371.
[32] X. U. E. Zhenglong, W. Guanhua, S. U. N. Hao, Z. Yunli, S. I. Chuanling, J. I. A. Hongyu, Research Status and Development Trend of Bio-based Dust Suppressants., Biomass Chemical Engineering 57 (2023). search.ebscohost.com/login.aspx?direct=true&profile=ehost&scope=site&authtype=crawler&jrnl=16735854&AN=163122535&h=d5RbQMeS8hIFV6S%2BExKofly%2BZiZe yROty4Co3kMbZYYgsHMTaJ2ApS2wWXmkuSJT4o5TUXh0mp%2B1RaHdZOyB0Q%3D%3D&crl=c (accessed Nov. 2, 2024).
[33] J. L. Sieger, B. G. Lottermoser, J. Freer, Effectiveness of Protein and Polysaccharide Biopolymers as Dust Suppressants on Mine Soils: Large-Scale Field Trials, Mining 3 (2023) 428-462.
[34] R. Wang, H. Yu, Y. Xie, W. Li, H. Qi, Study on protein-polysaccharide environmental foam dust suppressant based on Maillard reaction, Journal of Molecular Liquids 410 (2024) 125644.
[35] Y. Zhu, Y. Cui, Z. Shan, R. Dai, L. Shi, H. Chen, Fabrication and characterization of a multi-functional and environmentally-friendly starch/organo-bentonite composite liquid dust suppressant, Powder Technology 391 (2021) 532-543. doi.org/10.1016fj.powtec.2021.06.050.
[36] X. Dang, Z. Shan, H. Chen, Usability of oxidized corn starch-gelatin blends for suppression and prevention of dust, J of Applied Polymer Sci 134 (2017) app.44437. doi.org/10.1002/app.44437.
[37] R. Xu, H. Yu, H. Dong, Y. Ye, S. Xie, Preparation and properties of modified starch-based low viscosity and high consolidation foam dust suppressant, Journal of Hazardous Materials 452 (2023) 131238.
[38] S. Khadse, K. Sekhar, G. Begum, B. H. Rao, Effectiveness of Xanthan Gum and Guar Gum in Mitigating Dust Emission from Bauxite Residue Tailings Facility, Indian Geotech J (2024). doi.org/10.1007/s40098-024-01051-z.
[39] X. Wang, H. Chen, Y. Shi, Y. Lin, J. Yang, X. Li, Development of an eco-friendly dust suppressant based on modified guar gum: Performance and mechanism analysis, Powder Technology 439 (2024) 119681.
[40] H. Zhang, W. Nie, H. Wang, Q. Bao, H. Jin, Y. Liu, Preparation and experimental dust suppression performance characterization of a novel guar gum-modification-based environmentally-friendly degradable dust suppressant, Powder Technology 339 (2018) 314-325.
[41] M. Liu, Q. Meng, C. Niu, Y. Wang, G. Zhou, C. Xu, Y. Liu, Preparation and characterization of modified dual network dust suppression gel based on sodium alginate and soluble starch, Environ Sci Pollut Res 29 (2022) 69771-69784. doi.org/10.1007/s11356-022-20721-0.
[42] Y. Liu, C. Du, F. Yi, C. Cheng, M. Wang, Modified sodium alginate-based three-dimensional network hydrogel dust suppressant: Preparation, characterization, and performance, International Journal of Biological Macromolecules 274 (2024) 133408.
[43] W. Nie, W. Niu, Q. Bao, M. Yuan, W. Zhou, Y. Hua, F. Yu, C. Liu, S. Zhang, X. Zhang, Study on the combined dust suppression effect of sodium alginate and sodium fatty acid methyl ester sulfonate, Advanced Powder Technology 33 (2022) 103827.
[44] H. Wang, W. Nie, H. Zhang, H. Jin, Q. Bao, J. Yan, Q. Liu, A Synthesis of a Dust Suppressant Using the Cellulose Extracted from Maize Straw, Starch St& #228; Rke 72 (2020) 1900187. doi.org/10.1002/star.201900187.
[45] Y. Yang, Q. Zhao, Y. Mi, Preparation and Optimum Proposal of Biological Dust Suppressant Using Straw Based on Orthogonal Test, J. Highway Transp. Res. Dev. (English Ed.) 15 (2021) 8-17. doi.org/10.1061/JHTRCQ.0000771.
[46] Y. Liu, W. Nie, H. Jin, H. Ma, Y. Hua, P. Cai, W. Wei, Solidifying dust suppressant based on modified chitosan and experimental study on its dust suppression performance, Adsorption Science & Technology 36 (2018) 640-654. doi.org/10.1177/0263617417713624.
[47] G. Zhou, Z. Xing, Y. Tian, B. Jiang, B. Ren, X. Dong, L. Yi, An environmental-friendly oil-based dust suppression microcapsules: Structure with chitosan derivative as capsule wall, Process Safety and Environmental Protection 165 (2022) 453-462.
[48] C. Li, Recent progress in understanding starch gelatinization—An important property determining food quality, Carbohydrate Polymers 293 (2022) 119735. doi.org/10.1016/j.carbpol.2022.119735.
[49] J. Sun, G. Zhou, D. Gao, Z. Wei, N. Wang, Preparation and performance characterization of a composite dust suppressant for preventing secondary dust in underground mine roadways, Chemical Engineering Research and Design 156 (2020) 195-208. doi.org/10.1016/j.cherd.2020.01.030.
[50] Z. Liang, X. Cai, H. Hu, Y. Zhang, Y. Chen, Z. Huang, Synthesis of starch-based super absorbent polymer with high agglomeration and wettability for applying in road dust suppression, International Journal of Biological Macromolecules 183 (2021) 982-991.
[51] (PDF) Lignin as Potent Industrial Biopolymer: An Introduction, (n.d.). https://www.researchgate.net/publication/339875116_Lignin_as_Potent_Industrial_Biopoly mer_An_Introduction (accessed Apr. 25, 2025).
[52] Lignin and Lignans as Renewable Raw Materials: Chemistry, Technology and Applications Wiley, Wiley.Com (n.d.). https://www.wiley.com/en-be/Lignin+and+Lignans+as+Renewable+Raw+Materials%3A+Chemistry%2C+Technolog y+and+Applications-p-9781118597866 (accessed Apr. 25, 2025).
[53] Solidifying dust suppressant based on modified chitosan and experimental study on its dust suppression performance—Yanghao Liu, Wen Nie, Hu Jin, He Ma, Yun Hua, Peng Cai, Wenle Wei, 2018, (n.d.).journals.sagepub.com/doi/full/10.1177/0263617417713624 (accessed Apr. 25, 2025).
[54] K. Ravishankar, M. Venkatesan, R. P. Desingh, A. Mahalingam, B. Sadhasivam, R. Subramaniyam, R. Dhamodharan, Biocompatible hydrogels of chitosan-alkali lignin for potential wound healing applications, Materials Science and Engineering: C 102 (2019) 447-457. doi.org/10.1016/j.msec.2019.04.038.
[55] Y. Xu, B. Ma, Y. Zhang, Y. Fan, Optimal Preparation and Performance Study of Eco-Friendly Composite Chemical Dust Suppressants: A Case Study in a Construction Site in Chengdu, Materials 17 (2024) 2346. doi.org/10.3390/ma17102346.
[56] Gelatinizing Starch in Sodium Hydroxide/Glycerol Aqueous Solution at Room Temperature—Yang—2021—Starch-Stärke—Wiley Online Library, (n.d.). https://onlinelibrary.wiley.com/doi/abs/10.1002/star.202000152 (accessed Apr. 25, 2025).

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed is:

1. A biocompatible dust mitigation composition comprising a regenerated amylopectin starch hydrogel (RASH) composition.

2. The dust mitigation composition of claim 1, wherein the RASH composition comprises high amylopectin cornstarch.

3. The composition of claim 1, wherein the high amylopectin starch comprises about 90 wt. % amylopectin, about 91 wt. % amylopectin, about 92 wt. % amylopectin, about 93 wt. % amylopectin, about 94 wt. % amylopectin, about 95 wt. % amylopectin, about 96 wt. % amylopectin, about 97 wt. % amylopectin, about 98 wt. % amylopectin, about 99 wt. % amylopectin, or greater than about 99 wt. % amylopectin.

4. The composition of claim 1, wherein the composition is shelf stable.

5. The composition of claim 1, wherein the composition comprises a pH of about 6 to about 7.5.

6. The composition of claim 1, wherein the composition comprises about 0.5 wt. % high amylopectin starch, about 1.0% high amylopectin starch, about 2.0 wt. % high amylopectin starch, about 3.0% wt. % high amylopectin starch, about 4.0 wt. % high amylopectin starch, about 5.0% high amylopectin starch, and greater than about 5.0 wt. % high amylopectin starch.

7. The composition of claim 1, wherein the composition comprises a salt selected from the group consisting of NaCl, CaCl₂), MgCl₂, BaCl₂, NHCl, or any combination thereof.

8. The composition of claim 7, wherein the salt comprises about 0.01 wt. % to about 10 wt. % of the composition.

9. A method of producing an amylopectin starch hydrogel composition, the method comprising:
suspending an amylopectin-rich starch in water, thereby producing a starch solution;
stirring the starch solution at a temperature sufficient to induce starch gelatinization;
cooling the solution to room temperature;
subjecting the solution to a freeze-thaw process, thereby producing a foam; and grinding the foam into a powder, thereby producing a powder amylopectin starch hydrogel composition.

10. The method of claim 9, wherein:
the powder amylopectin starch hydrogel composition comprises about 90 wt. % amylopectin, about 91 wt. % amylopectin, about 92 wt. % amylopectin, about 93 wt. % amylopectin, about 94 wt. % amylopectin, about 95 wt. % amylopectin, about 96 wt. % amylopectin, about 97 wt. % amylopectin, about 98 wt. % amylopectin, about 99 wt. % amylopectin, or greater than about 99 wt. % amylopectin;
the powder comprises a particle size of about 50 μm to about 700 μm;
the temperature sufficient to induce starch gelatinization is about 90° C. or about greater than 90° C.; or
any combination thereof.

11. The method of claim 10, further comprising adding an aqueous solution to the powder amylopectin starch hydrogel composition, thereby producing a regenerated amylopectin starch hydrogel (RASH).

12. The method of claim 10, wherein the powder comprises at least 50% particles with a particle size of at least 100 μm.

13. The method of claim 11, wherein the RASH comprises:
about 0.5 wt. % of the powder amylopectin starch hydrogel composition, about 1.0% of powder amylopectin starch hydrogel composition, about 2.0 wt. % of the powder amylopectin starch hydrogel composition, about 3.0% wt. % of the powder amylopectin starch hydrogel composition, about 4.0 wt. % of the powder amylopectin starch hydrogel composition, about 5.0 wt. % of the powder amylopectin starch hydrogel composition, or greater than about 5.0 wt. % of the powder amylopectin starch hydrogel composition; and
about 0.01 wt. % to about 10 wt. % of a salt selected from the group consisting of NaCl, CaCl₂), MgCl₂, BaCl₂, NH₄Cl.

14. A method of suppressing particulate matter comprising applying the regenerated amylopectin starch hydrogel (RASH) of claim 11 to a loose particulate material, thereby forming agglomerated particles.

15. The method of claim 14, wherein:
the RASH is homogenous;
the RASH is regenerated in a liquid at about 65° C. to about 80° C.;
the RASH comprises a viscosity of about 0.001 P·s, to about 0.3 P·s at room temperature;
the RASH comprises about 0.5 wt. % to about 5.0 wt. % of a powder amylopectin starch hydrogel composition; or
any combination thereof.

16. The method of claim 14, wherein the applying comprises spraying.

17. The method of claim 14, wherein the agglomerated particles form a soil crust.

18. The method of claim 14, wherein the RASH is applied at about 1.0 L/m² to about 4.0 L/m².

19. The method of claim 14, wherein the soil crust comprises a threshold detachment velocity (TDV) of greater than about 25 m/s.

20. The method of claim 14, wherein the particulate matter comprises PM10, PM1, PM2.5, or a combination thereof.
